(19) United States
(12) Patent Application Publication
(10) Pub. No.: US 2017/0161774 A1
(43) Pub. Date: Jun. 8, 2017

(54) METHODS AND SYSTEMS FOR MANAGING AND ROUTING TARGETED CONTENT OVER NETWORKS

(71) Applicant: The Rubicon Project, Inc., Playa Vista, CA (US)

(72) Inventors: Bret Alan Gorsline, Flemington, NJ (US); William James Dudziak, Los Angeles, CA (US); James Neal Richter, Murray, UT (US)

(21) Appl. No.: 14/958,199

(22) Filed: Dec. 3, 2015

(51) Int. Cl. G06Q 30/02

(52) U.S. Cl. CPC G06Q 30/0244; G06Q 30/0246; G06Q 30/0261; G06Q 30/0269; G06Q 30/0275; G06Q 30/0277

(57) ABSTRACT

Methods and systems of routing targeted content to networked destinations are described. The targeting may be performed utilizing demographic targeting, property targeting, behavioral targeting, and/or event targeting. An adjusted value for a targeted guaranteed content item associated with an entity may be dynamically calculated using a previously specified value communicated with the entity and/or historical delivery performance for the targeted guaranteed content item. A content request may be received from a user agent. A determination is made as to whether the targeted guaranteed content item is eligible to be delivered to the user agent using a targeting criterion and a dynamic pace setting. The targeted guaranteed content item may participate, along with real time open market bids, in a real time impression auction. The adjusted value may be used in the real time auction to determine which item of content is to be routed to the user agent.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

### BACKGROUND OF THE INVENTION

Field of the Application

The present disclosure relates to managing and routing digital content, and in particular, managing and routing targeted digital content.

Background

Conventionally, content that is associated with a guaranteed delivery will consistently be delivered over a network prior to content that is not associated with a guaranteed delivery.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

An aspect of the disclosure is the integration of guaranteed ads into an open real time bidding market, enabling guaranteed ad campaign goals to be met while still accepting more valuable real time bids with greater frequency than is possible using conventional waterfall techniques, where ads whose impressions are “guaranteed” are treated as having the highest priority and are served first, and then those ads with the next highest priority are served, and so on. The guaranteed ads may optionally be targeted ads, wherein the targeting may optionally utilize one or more of the following: demographic targeting (e.g., gender, age, income, location, etc.), property targeting (e.g., specifying a particular website, website page, app, or other property where an ad should be shown), behavioral targeting (e.g., which sites a user has previously visited, what searches the user has performed, what purchases the user has made, etc.), or event targeting (e.g., a specific scheduled sporting event, such as an individual game or a tournament).

Another aspect of this disclosure provides optional technical benefits. By providing a unified auction platform that enables open market real time bids to compete for more ad impressions, the number of system components and amount of needed inter-device component communication may optionally be reduced as compared to conventional architectures that utilize separate ad exchange systems and direct ad systems which need separate hosting servers and communications between the ad exchange systems and direct ad systems. The disclosed architecture may beneficially thus reduce the amount of servers and bandwidth needed. Further, the reduced number of system components may result in higher system reliability, and a higher mean time between failures, providing longer periods of uninterrupted access to ad network systems, publisher systems, and the like.

In addition, an aspect of the disclosure enables a seller to specify a preferred behavior for responding to a determination of an over-commitment of inventory. For example, the seller may specify that the system is to focus on ensuring that the delivery goals of guaranteed ads are met, or that the focus is to be on maximizing revenues from the delivery of inventory, or that a balanced comprise is to be achieved between ensuring that the delivery goals of guaranteed ads are met and maximizing revenues from the delivery of inventory.

An aspect of the disclosure relates to a targeted content routing system, comprising: a computer data repository that stores transaction records, the computer data repository comprising a plurality of geographically distributed non-transitory storage devices and configured to log content serving data and to synchronize content serving data among the plurality of geographically distributed datacenters, so that content serving data is replicated across the geographically distributed datacenters; a network interface; and a computing system comprising one or more computing devices, the computing system programmed to implement: a content matching engine configured to determine which third party content is suitable for a webpage; a unified auction engine configured to: calculate an adjusted value for a first targeted guaranteed item of content associated with a first entity based at least in part on: a previously specified value communicated with the first entity; historical delivery performance accessed from the computer data repository for the first targeted guaranteed item of content during a first time period; and a delivery schedule for the first targeted guaranteed item of content; receive, using the network interface, a request for content from a user agent; determine, utilizing the content matching engine, whether the first targeted guaranteed item of content is eligible to be delivered to the user agent based at least in part on: at least one targeting criterion associated with the first targeted guaranteed item of content, and a pace setting associated with the first targeted guaranteed item of content; at least partly in response to a determination that the first targeted guaranteed item of content is eligible to be delivered to the user agent based at least in part on the targeting criterion and the pace associated with the first targeted guaranteed item of content, cause the first targeted guaranteed item of content to participate in a real time impression auction, transmit, using the network interface, a request for open market bids to remote systems, receive, using the network interface, from at least a portion of the remote systems a first plurality of open market bids, the first plurality of open market bids associated with respective bid values, for respective non-guaranteed items of content for an impression associated with the content request from the user agent; determine if the adjusted value for the eligible first targeted guaranteed item of content is less than at least a first bid associated with a first non-guaranteed item of content; at least partly in response to a determination that the adjusted value for the eligible first targeted guaranteed item of content is less than at least the first bid associated with the first non-guaranteed item of content, cause a non-guaranteed item of content to be routed for display to the user agent; and at least partly in response to a determination that the adjusted value for the eligible first targeted guaranteed item of content is greater than the received first plurality of open market bids for respective non-guaranteed items of content, cause the first targeted guaranteed item of content to be routed for display to the user agent.

An aspect of the disclosure relates to a computerized method of routing targeted content, the method comprising: calculating, by a content routing system comprising a data processing device, a real time impression auction system, and a campaign data store that stores at least campaign targeting criteria and campaign schedules, an adjusted value for a first targeted guaranteed item of content associated with a first entity based at least in part on: a previously specified value communicated with the first entity; historical delivery performance for the first targeted guaranteed item of content during a first time period; and a delivery schedule for the first targeted guaranteed item of content; receiving, at the content routing system, a request for content from a user agent; determining, by the content routing system, whether the first targeted guaranteed item of content is eligible to be delivered to the user agent based at least in part on: at least one targeting criterion associated with the first targeted guaranteed item of content, and a pace setting associated with the first targeted guaranteed item of content; at least partly in response to determining that the first targeted guaranteed item of content is eligible to be delivered to the user agent based at least in part on the targeting criterion and the pace associated with the first targeted guaranteed item of content, causing the first targeted guaranteed item of content to participate in a real time impression auction hosted by the real time impression auction system, requesting, using the real time impression auction system, open market bids from a plurality of remote systems, receiving, by the real time impression auction system, a first plurality of open market bids from at least a portion of the plurality of remote system, the first plurality of open market bids associated with respective bid values, for respective non-guaranteed items of content for an impression associated with the content request from the user agent; determining, by the real time impression auction system, if the adjusted value for the eligible first targeted guaranteed item of content is less than at least a first bid associated with a first non-guaranteed item of content; at least partly in response to determining that the adjusted value for the eligible first targeted guaranteed item of content is less than at least the first bid associated with the first non-guaranteed item of content, causing, by the real time impression auction system, a non-guaranteed item of content to be routed for display to the user agent; and at least partly in response to determining that the adjusted value for the eligible first targeted guaranteed item of content is greater than the received first plurality of open market bids for respective non-guaranteed items of content, causing, by the real time impression auction system, the first targeted guaranteed item of content to be routed for display to the user agent.

An aspect of the disclosure relates to a computer storage system comprising a non-transitory storage device, said computer storage system having stored thereon executable program instructions that direct a computer system to at least: calculate an adjusted value for a first targeted guaranteed item of content associated with a first entity based at least in part on: a previously specified value communicated with the first entity; historical delivery performance for the first targeted guaranteed item of content during a first time period; and a delivery schedule for the first targeted guaranteed item of content; receive a request for content from a user agent; determine whether the first targeted guaranteed item of content is eligible to be delivered to the user agent based at least in part on: at least one targeting criterion associated with the first targeted guaranteed item of content, and a pace setting associated with the first targeted guaranteed item of content; at least partly in response to a determination that the first targeted guaranteed item of content is eligible to be delivered to the user agent based at least in part on the targeting criterion and the pace associated with the first targeted guaranteed item of content, cause the first targeted guaranteed item of content to participate in a real time impression auction, transmit a request for open market bids to one or more systems, receive from at least a portion of the one or more systems a first plurality of open market bids, the first plurality of open market bids associated with respective bid values, for respective non-guaranteed items of content for an impression associated with the content request from the user agent; determine if the adjusted value for the eligible first targeted guaranteed item of content is less than at least a first bid associated with a first non-guaranteed item of content; at least partly in response to a determination that the adjusted value for the eligible first targeted guaranteed item of content is less than at least the first bid associated with the first non-guaranteed item of content, cause a non-guaranteed item of content to be routed for display to the user agent; and at least partly in response to a determination that the adjusted value for the eligible first targeted guaranteed item of content is greater than the received first plurality of open market bids for respective non-guaranteed items of content, cause the first targeted guaranteed item of content to be routed for display to the user agent.

### BRIEF DESCRIPTION OF THE DRAWINGS

Embodiments will now be described with reference to the drawings summarized below. These drawings and the associated description are provided to illustrate example embodiments, and not to limit the scope of the invention.

FIGS. 1A-1D illustrate aspects of example architectures.

FIGS. 2, 3, and 4 illustrate example processes.

FIGS. 5A-5C illustrate example delivery curves.

FIG. 6 illustrates an example user interface.

### DETAILED DESCRIPTION

Aspects of the disclosure relate to online content placement campaigns, the selection and routing of content for display on electronic media, and the management of display space inventory. Display space inventory may be in the form of space on websites, emails, instant messaging, games, etc.

Conventionally, priority levels are used to rank ad campaigns according to their importance. For example, if two ads are both eligible for the same impressions, the ad with the higher priority will win the impression.

Conventional techniques for serving digital advertisements utilize a sequential, waterfall technique, where ads whose impressions are “guaranteed” are treated as having the highest priority and are served first, and then those ads with the next highest priority are served, and so on. Conventionally, only when there are no guaranteed ads that need to be delivered, is open market real-time bidding invoked to sell ad impressions, where advertising inventory is bought and sold on a per-impression basis, in substantially real time, typically to the highest bidder. Thus, conventional techniques do not enable open market buyers that are willing to pay more than the value of the guaranteed ads to obtain priority over such guaranteed ads with respect to ad placement.

By contrast, certain embodiments described herein enable sellers of impressions (e.g., publishers) to enhance revenue by dynamically determining the relative priority of guaranteed ads and non-guaranteed ads (which may be targeted ads), optionally in substantially real time (e.g., while the webpage on which the ad is being placed is loading, which may be less than 100 ms, or less than 10 ms after an ad request is received from the browser loading the webpage). For example, certain methods and systems disclosed herein enable ad impressions being sold via a real-time bidding system to be assigned a higher priority than guaranteed ads in certain situations. This technique enables a greater number of ad impressions to be sold via real-time bidding (e.g., at prices higher than a contract price for a guaranteed ad) as compared to the conventional waterfall technique, while still ensuring that guaranteed ads are placed in a manner that satisfies the corresponding guarantees. It is understood, that although reference may be made to advertisements for illustrative purposes, the methods and systems disclosed herein are applicable to other content types (e.g., images, text and videos that are not advertisements for products or services).

Thus, an aspect of the disclosure is the integration of guaranteed ads (or other content) into the open real time bidding market, which enables guaranteed ad campaign goals to be met, while still accepting more valuable real time bids with greater frequency than is possible using the conventional waterfall technique.

Another aspect of this disclosure provides optional technical benefits. By providing a unified auction platform that enables open market real time bids to compete for more ad impressions, the number of system components and amount of needed inter-device component communication may optionally be reduced as compared to conventional architectures that utilize separate ad exchange systems and direct ad systems which need separate hosting servers and communications between the ad exchange systems and direct ad systems. The disclosed architecture may beneficially thus reduce the amount of servers and bandwidth needed. Further, the reduced number of system components may result in higher system reliability, and a higher mean time between failures, providing longer periods of uninterrupted access to ad network systems, publisher systems, and the like. Still further, the disclosed architecture may ensure that certain advertisements are not over-delivered by controller the pace of ad serving.

In addition, an aspect of the disclosure enables a seller to specify a preferred behavior for responding to a determination of an over-delivery of inventory. For example, the seller may specify that the system is to focus on ensuring that the delivery goals of guaranteed ads are met, or that the focus is to be on maximizing revenues from the delivery of inventory, or that a balanced comprise is to be achieved between ensuring that the delivery goals of guaranteed ads are met and maximizing revenues from the delivery of inventory.

An overview of certain aspects of example online ad campaigns will now be provided to provide context to certain aspects of the disclosed systems and methods. In particular, discussions regarding guaranteed ads, non-guaranteed ads, sponsorships, campaign pacing, and other aspects of ad campaigns are set forth below.

Generally, when a user accesses a certain property, such as a webpage via a browser, a URL directs the user browser to source access the page from a publisher system (e.g., a publisher server). The publisher server transmits corresponding webpage HTML to the user browser. The webpage HTML may include one or more ad tags. The ad tags instruct the user browser to request an ad. The browser may contact the publisher's ad server directly, an ad network, and/or an ad exchange with the ad request. In response, the ad is then provided by a one of the foregoing systems to the user browser for display. Various techniques may be used to determine which ad is served. For example, as discussed herein, a unified auction engine may be used to determine which ad will win an ad impression.

Establishing a guaranteed ad delivery arrangement may be used to implement a media campaign in a way that is advantageous to both the buyer of ad impressions and the seller of ad impressions (e.g., a publisher of online content). In a guaranteed ad arrangement, a buyer may contract with a seller of ad impressions for a substantially fixed volume of inventory between specific dates. Typically, for guaranteed ads, there is there is a contract between an advertisement entity and a placement entity (e.g., a seller of ad impressions) that specifies one or more ad delivery goals. For example, the contract may specify that the delivery goal is to be met in a time-balanced way and that the goal is not to be significantly exceeded. The contract may specify that if the goal is not met, or is not meet by greater than a specified threshold (e.g., not met by 5%, 10%, or other threshold), the seller may be penalized (e.g., the seller may need to provide additional ad impressions for free or at a reduced price, and/or may need to pay a financial penalty).

Thus, for example, the seller may ‘guarantee’ that the seller will make its best efforts to deliver the type and quantity of impression inventory specified in the contract, and the buyer may guarantee it will provide ad creatives (e.g., an object that contains the data for visually rendering the ad, such as the ad itself or a link to the ad) by a specified date and pay for the impression inventory at the agreed upon rate. By way of example, an ad creative may be a banner, interstitial (e.g., an ad shown in a separate window, as a pop-up window, as pop-under window, within a main window as a floating ad, etc.), in-page (an ad that is embedded in the main window), etc. An ad creative may be an HTML creative, a FLASH file, a movie file, an image file (e.g., JPEG, PNG, GIF, etc.), a text file, etc.

Sellers and buyers of ad impression inventory may have different reasons for engaging in a contract for guaranteed ad placement. Advantageously for the seller, the seller obtains a contractual commitment that a future amount of ad impression inventory will generate revenue, enabling the seller to more accurately perform sales forecasts and financial planning. In addition, the guarantee may place a legal obligation on the buyer to timely provide the creatives for the advertisement, ensuring the inventory does not go unsold. In addition, the contract for guaranteed ad placement may optionally require that the buyer pre-pay for some portion of the delivery.

Advantageously for the buyer, the buyer is guaranteed a certain quality and quantity of impression inventory over a certain amount of time at a certain price. Such certainty enables the buyer to more accurately project marketing budgets and return on investment (ROI) for the ad campaign budget. Further, the buyer may often receive a higher level of service from the seller with respect to guaranteed campaigns, as there is a contract obligating sellers to start the campaign on time, and there are mechanisms enabling the buyer to monitor the delivery of ad impressions and the conformance of such delivery to the contract terms.

By contrast, when ad impressions are sold on a non-guaranteed basis, if impression inventory is available that matches the buyer's goals/specifications, the inventory may be sold to the buyer, but the seller does not make guarantees as to a volume of impressions and the buyer does not make guarantees as to how many impressions the buyer will purchase. Thus, impressions may be sold on an impression-by-impression basis.

An example process for arranging a guaranteed ad campaign will now be described. A buyer (which may be an agent of the buyer) may submit a request for proposal (RFP) to a seller containing the buyer's goals and/or requirements (e.g., an electronic proposal via an electronic form). The seller may respond with proposal identifying property (e.g., a website, a game, an app, etc.) and/or audience (e.g., audience age range, gender, geographic regions, interests, etc.) that meets the buyer's goals and/or requirements. The seller's RFP may be received and stored on a seller computer system. Responding to the RFP, the seller (which may be an agent of the seller) may generate and provide a forecast of available impressions and/or available unique impressions that correspond to the RFP goals and/or requirements. The parties may adjust their proposed terms as part of a negotiation process.

Once the buyer and seller have come to an agreement on the terms, the parties may execute an Insertion Order (IO). The IO may specify some or all of the following and/or other information: an ad campaign name, the property or properties and zone(s) on which the ads will be placed, the identity of the buyer giving the order, the ads to be run (or the source of the ads), the ad type, the ad dimensions, the campaign beginning and end dates, the number of impressions to be delivered (e.g., on a daily basis and/or overall), the total cost, the cost per thousand impression (CPM), the cost per acquisition (CPA), the cost per click (CPC), any discounts to be applied, penalties or stipulations relative to the failure to deliver the impressions as agreed, and reporting requirements (e.g., by day, by creative execution, content area (ad placement), number of impressions, clicks, spend/cost, etc.). Insertion orders may contain a mix of guaranteed and performance/non-guaranteed elements.

The IO may be entered into and stored by the seller system (which may optionally be the system of a service provider of the seller) to reserve the specified impression inventory, and the creatives are delivered by the buyer (e.g., to the seller system or other entity system that will receive, store, and serve the creatives as ads). Typically, the non-guaranteed elements of the ad campaign are under less operational and financial scrutiny, and so may need less reporting.

A contract may comprise a set of standard (e.g. Interactive Advertising Bureau (IAB) standard terms) and/or customized Terms and Conditions (T&Cs) for the order. Such terms may be attached/associated with the IO.

An ad delivery contract/IO may include one or more line items. A line item may define some or all of the following: the ad to be run, the ad unit the ad will run in, the type of ad creative, the ad dimensions, the target audience, and any custom targeting (e.g., geography).

If the IO is complied with, the ad campaign will start on the specified start date, and will deliver impressions in a “reasonably balanced” way, and will meet the overall impression goal on the last day of the campaign. However, often there may be delivery problems which may prevent the IO from being fully complied with, and which may result in over-delivery or under-delivery of ad impressions.

Certain aspects of ad delivery and delivery pacing will now be discussed.

Advertisers generally want to have their message/ads distributed over time so that they reach more unique users and reach users over a longer time period of interest. Ideal delivery occurs when the impressions delivered meets the daily goal specified in the IO (or derivable from the specified total impressions and length of the campaign) every day for the term of the campaign. Over-delivery occurs when an ad campaign has delivered significantly more ad impressions than it should have by a given date (e.g., accruing more costs for impressions in one day than the amount of the buyer's average daily budget), and is on schedule to deliver the total contracted for number of impressions for the campaign before reaching the campaign end date. Under-delivery occurs when the campaign has delivered significantly less than it should have by a given date, and is on schedule to deliver less than the total number of impressions for the campaign by the campaign end date.

Certain techniques may be employed to avoid or reduce delivery problems and to ensure that the execution of an ad campaign comes closer to ideal delivery. Optionally, a seller may utilize delivery pacing controls to better control the rate of delivery.

For example, the pacing controls may be set to cause the impression delivery to be performed in a relatively smooth manner so that the ad impressions are delivered relatively evenly over the course of the ad campaign period. By way of further example, the pacing controls may be dynamically set to cause the impression delivery to be performed in a relatively faster manner so that the ad impressions are delivered relatively fast (e.g., at a rate significantly higher than the average daily delivery rate for a past period of time to make up for earlier missed impression delivery goals). By way of still further example, the pacing controls may be dynamically set to cause the ad impression delivery to be performed “as fast as possible” to thereby utilize every matching available/won impression without throttling (optionally except for delivery caps), to aggressively make up for earlier significantly missed impression delivery goals or to achieve as many impressions as possible for an anticipated event (e.g., a sporting event, conference, etc.) that may attract large numbers of targeted viewers. By way of still further example, the pacing controls may be set to front-load the delivery of impressions, where a disproportionate percentage of impressions are delivered in an initial portion of the campaign. By way of yet further example, the pacing controls may be set to rear-load the delivery of impressions, where a disproportionate percentage of impressions are delivered at an end portion of the campaign.

The pacing controls may be set to utilize priority tiers in determining which buyer obtains which impression, where, conventionally, a buyer with a higher priority will receive or tend to receive impressions before a buyer with a lower priority. Artificial price points may be utilized, where an entity (e.g., a seller or ad trafficker) may inflate or deflate the ‘value price’ of impression to tune the delivery. The end dates of a campaign may be dynamically adjusted to take advantage of planned or anticipated traffic spikes. The system may include a pacing system that takes delivery time zone into account when pacing ads (e.g., during a specified portion of a date range, such as the last 2 days of the date range).

Certain optional example pacing techniques will now be discussed in greater detail.

Front-loading may be utilized so that the impression delivery numbers will be ahead of schedule (e.g., by about the middle of the campaign date range) so that insufficient inventory towards the end of the campaign will not result in missing the total impression goal or requirement at all or by as much, and so that there will not be large numbers of campaigns trying to “catch-up” at the end of the month. The amount of front-loading may vary by campaign or organization. For example, a pacing control rule may specify that impressions should be briefly front-loaded to achieve a goal that is as much as 40% (or other percentage) higher than a goal without frontloading, and then gradually decline the rate of impression delivery so the cumulative impression delivery is 5% (or other percentage) ahead of schedule as the campaign draws to its end. For example, a pacing control rule may specify “reach X % by Y % of the campaign date period” (e.g., reach 85% of the total impression goal by 75% of the ad campaign time period). The pacing control rule may optionally be received by the system from a user via an electronic form displayed on a user terminal.

As noted above, campaign end dates may be dynamically adjusted to ensure that impression delivery goals are better met. For example, it may be desirable to prevent unexpected traffic spikes (e.g. resulting from some content or property suddenly going viral) from causing guaranteed impressions to be served above some “balanced delivery” goal. In such a situation and in contrast to conventional approaches, the unanticipated increase in traffic may be used to serve impressions for non-guaranteed ads rather than, in whole or in part, being used to serve impressions for guaranteed ads. However, optionally expected increased inventory resulting from traffic spikes (e.g., resulting from scheduled sporting events, awards ceremonies, or conferences) may be sold to a buyer (who will expect delivery of inventory resulting from the anticipated spike), in which case delivery of guaranteed inventory may be desirable. For example, the end date may be manually or automatically shifted to an earlier date to shorten the campaign period to thereby “trick” the ad system into delivering more impressions earlier to ensure the total number of delivered impressions is still met by the earlier end date, and then shifting the end date to a later date (e.g., the original end date) after the spike is or is about to be over.

As noted above, there may be an under-delivery of ad impressions during the course of a guaranteed ad campaign. If, as a result of an under-delivery situation, a guaranteed part of an ad campaign may not meet the overall impression delivery goal, conventionally the seller may in some arrangements be obligated to provide the buyer with a notification that the goal may not be met. The buyer and seller may decide on a remedy (e.g. raise the priority of the buyer, shift targeting to other publications, investigate creative tracking problems) or may just agree to monitor impression delivery for the remainder of the campaign. If the guarantee is not met by the campaign end date, penalties specified in their agreement may be applied, or the parties may negotiate a resolution. For example, the parties may agree that the seller is to provide a refund of some amount, provide a credit for future ad impressions, extend the end date, or agree to have the seller to make up the difference. Generally, conventionally the resolution results in a cost to the seller, such as a direct loss of current revenue, the selling of future impression inventory at a lower price or at below market price, and/or operational overhead.

In order to avoid the penalties associated with under-delivery, sellers may add a ‘bonus’ to the goal in the form of free impressions that give added certainty the delivery will meet the contracted goal, however, there may be a limit as to the percentage the bonus can be of the goal (e.g., if there is a buyer ad server or other media costs involved). Optionally, there may be a default bonus (e.g., 1%, 2%, 3%, 4%, 5%, other percentage). Thus, it would be advantageous for the seller to ensure that under-delivery does not occur.

Similarly, if an ad campaign delivers more impressions than the contracted goal, the parties may negotiate a resolution. For example, the seller may be responsible for delivering a certain minimum amount of impressions through the campaign end date in order to obtain the audience reach specified by the buyer. Often, extra impressions delivered above the goal are not paid for by the buyer, and even more disadvantageously for the seller, over delivery above a certain amount or percentage may result in the seller having to pay some or all of the buyer's media costs associated with the over-delivery or provide credits on fees for over-delivered impressions.

As will be discussed elsewhere herein, certain embodiments disclosed herein aid in reducing the frequency and/or amount of over-delivery and under-delivery.

The system may be configured to attempt to perform an ideal daily delivery. Ideal daily delivery may be defined to be (Line Item Impression Goal+Bonus)/(Total Days in Line Item). The system may be configured to attempt to perform a balanced delivery. Balanced delivery may be specified as being no more than a specified percentage (e.g., about 10%, 15%, 20%, or 25%) ahead or behind of an ideal delivery curve/schedule on a given day. Optionally, the balanced delivery may also cause a specified delivery distribution over the day. For example, the specified delivery distribution may specify that delivery must occur in a specified number of hours (e.g., 16, 17, 18, 19, 20, 21, 22, 23, or 24 hours) of the day to ensure that the delivery does not occur in just a few hours. By way of illustration, the specified delivery distribution may ensure that all the daily impressions are not delivered in the first four hours of the day, and not thereafter. Balanced delivery for a line item may also be specified over the entire period between the start date and end date. For example, balanced delivery for a line item may specify that a certain percentage of its days should be within a specified percentage of the ideal delivery curve (e.g., 80% of the line item days should be within 20% of the ideal delivery curve).

The system may be configured to prevent delivery of more than a specified percentage (e.g., 0.5%, 1%, 2%, etc.) beyond the specified goal and bonus. The system may be configured to detect when the system has under-delivered and to accelerate delivery to catch up to the ideal delivery, without materially negatively affecting other campaigns. For example, as discussed elsewhere herein pace (also referred to as eligibility) and/or ad value adjustment maybe be used to accelerate delivery to catch up with a desired delivery goal.

The system may be configured to determine when a line item delivery is on the desired pace at a given point in time (optionally within a specified tolerance), and when the line item delivery is on the desired pace, enhance revenue by accepting open market requests (e.g., with reasonable value) and delivering inventory in response to such open market requests. The pacing may be dynamically adjusted.

In addition to guaranteed campaigns, there may be sponsorship campaigns. Certain aspects of sponsorship campaigns will now be described. Sponsorship advertising is sometimes referred to as “share-of-voice”, as the advertiser receives a specified share of page views for a given site. A percentage goal may be set for each sponsorship line item, which is used to determine the percentage of matching impression requests each sponsorship will be served. A sponsored campaign may have a start and end date and no specific impression goals. To ensure the sponsorship goals are met, conventionally sponsorships are generally served ahead of other line items of the same priority, up to the set goal. An extended form of a sponsorship is the “roadblock,” where every unit or subsets of units on a webpage, or other designated property is taken by the same advertiser (e.g., for a coordinated branding effect).

By way of illustration, if the goal is set to 100% for a first sponsorship, and no other sponsorships target the same inventory and criteria, then the all the corresponding ad impressions will be served exclusively to the first sponsorship. If the sponsorship percentage is set to less than 100%, then non-sponsorship line items of equal and lower priority can be served ad impressions along with ad impressions served to the first sponsorship. A seller may offer sponsorships in order to provide prominent branding placement on its property (e.g., enable a brand to be the only or the most prominent advertiser on webpage or a website). A seller may place sponsorships in valuable eye-catching locations, and may charge a premium for such sponsorships. Sponsorships may be sold on the basis of cost per thousand impressions (CPM), cost per click (CPC), cost per day (CPDA), or on a flat-fee basis rather than by a fee per impression(s). Even when the sponsorship is on a flat fee basis, an impression estimate may be required or provided.

Sponsorship ad units may be exclusive and run in separate ad units (e.g. Intromercials, skins, windows, etc.) and may not appear at all if they are not sold. However, sponsorships may be IAB standard ad units (e.g., leaderboard, skyscraper, etc.) if so specified.

Thus, for example, an ad agency may want to purchase a sponsorship to reach a seller's audience with a high profile branding opportunity. A seller/ad trafficker may want to enter into an exclusive sponsorship arrangement with either a flat fee or an impression-based fee. Optionally a seller and a buyer (e.g., an ad agency) may enter into a shared sponsorship arrangement.

As noted above, the guaranteed priority levels may be configured so that they are not in the form of conventional “waterfall” style tiers. Optionally, adding priority to a guaranteed line item will raise its effective value in an RTB auction. Optionally, however, sponsorships are enforced regardless of the effective, adjusted value.

Certain example ad campaign frameworks will now be discussed in greater detail to provide context for certain aspects of the disclosure.

There are several types of ad campaign frameworks that may be made available. For example, there may a real time bidding framework that initiates requests to specific demand side platforms for bids for impression inventory, wherein impressions may be sold on an impression-by-impression basis to a bidder (e.g., the highest bidder). Another framework may involve ad networks pre-setup by the system operator (e.g. as opposed to a seller/publisher). For example, the system may provide a seller an ad code to place on the seller's site, which when placed will cause the site to substantially instantly begin requesting and displaying advertisements via the pre-setup advertising networks setup by the system operator. Still another framework may be a baseline ad framework which will initiate requests to advertisement networks specified by the seller. Yet another framework may be a direct ad framework, which may be setup by the seller with advertising networks with whom the seller has a direct relationship.

For example, the seller may setup a direct non-guaranteed campaign, where there is no commitment as to how many impressions will be received for an ad. By way of further example, the seller may setup a direct campaign, where there is a commitment by the seller that the seller will make best efforts to deliver a stated number of impressions. In addition, a seller may have a house campaign, serving the seller's own ad inventory without a fee, to serve internal marketing ads.

Real time bidding (RTB) style guarantees may also be utilized. For example, in a Demand Side Platform (DSP RTB) environment which enables agencies or other entities to purchase advertising inventory for their clients via a real time auction, the buyer may agree to bid on a certain percent of requests from the seller, and the seller agrees to let the buyer win a certain percent of requests even if other buyers have bid higher amounts. An identifier (a Deal ID) may be utilized to indicate such an arrangement and/or other agreement terms, such as priority, transparency, floor pricing, data, etc. The identifier may be provided to and stored by the DSP and also by a Supply-side platform (SSP) that enables publishers or other sellers to manage their advertising impression inventory and to enhance or maximize revenue with respect to selling impressions. A Deal ID may be passed in a bid request or bid response. The DSP may be used to gather bids for ad impressions. The SSP, on the publisher side, may interface to an ad exchange, which in turn interfaces to the DSP on the advertiser side to enable online advertising to be served to a selected target audience. For example, the targeting may optionally utilize one or more of the following: demographic targeting (e.g., gender, age, income, location, etc.), property targeting (e.g., specifying a particular website, website page, app, or other property where an ad should be shown), behavioral targeting (e.g., which sites a user has previously visited, what searches the user has performed, what purchases the user has made, etc.), or event targeting (e.g., a specific scheduled sporting event, such as an individual game or a tournament). User profile data (e.g., demographic data, behavioral data, etc.), may be collected in order to better target advertisements. RTB may be used to complete DSP transactions.

For example, rules may be generated that instruct the DSP that a line item must bid on 50% of all eligible requests. The rules may also instruct the DSP to let bids associated with the Deal ID win 60% of the bids, even if the bids associated with the Deal ID are not the highest bid.

Certain examples of unified auction systems and methods will now be described in greater detail.

As noted above, embodiments described herein enable sellers of impressions (e.g., publisher) to enhance revenue by dynamically determining the value of guaranteed ads, optionally in substantially real time. For example, in contrast to conventional systems, systems disclosed herein enable non-guaranteed ads to compete with guaranteed ads in certain situations in a real-time bidding auction. Optionally, an adjusted ad value (sometimes referred to herein as an optimized CPM (oCPM) or effective auction value) is utilized for guaranteed ads, which may differ from the contract value of the guaranteed ads. For example, the oCPM may be lower or higher than the contract value and may reflect a variety of criteria. The oCPM may be used to enable the guaranteed ad to compete for impressions with non-guaranteed ads utilizing a real time bidding platform. The oCPM may be determined heuristically. The oCPM and/or pace may be dynamically calculated and adjusted (e.g., every minute, every 5 minutes, every 10 minutes, every hour, every 4 hours, etc. and/or in response to an event).

For example, an optimized delivery schedule may be generated for a campaign line item, and the oCPM and/or pace of the ad may be continuously adjusted based on historical delivery performance (e.g., more than 5 or 10 minutes old) and recent delivery performance (e.g., less than 5 or 10 minutes old) to achieve the optimized delivery schedule, or a close approximation to the optimized delivery schedule, while still allowing more “valuable” non-guaranteed ads to win impressions over guaranteed ads with lower oCPMs (even though the bid amount of the non-guaranteed ad is lower than the contract value for the guaranteed ad). For example, the system may determine if the current oCPM and/or pace need to be adjusted every minute, every 5 minutes, every 10 minutes, or otherwise to reduce the problems associated with traffic spikes and troughs.

An example algorithm for generating the oCPM for a guaranteed ad will now be discussed in greater detail.

By way of illustration, some or all of the following criteria may be utilized by an algorithm incorporated into a yield optimization engine executed by the system in determining how to adjust a value, relative to the contract value, of a guaranteed campaign ad (to be used as a “bid” in an open RTB platform) and/or in determining whether an open market real time bids should be allowed to compete with a guaranteed campaign for a given impression:

1. Whether the campaign is in a frontloading stage, where the number of impressions for a given day are to exceed the daily impression goal (e.g., 5% higher). As discussed elsewhere herein, certain guaranteed campaigns may be frontloaded to ensure that insufficient inventory towards the end of the campaign will not result in an under-delivery, and so that there will not be large numbers of campaigns trying to “catch-up” at the end of the month to meet their monthly impression delivery goals. Thus, for example, the value of the guaranteed ad may be adjusted upwards during such a frontloading stage to increase the likelihood it will win impressions during the frontloading stage.

2. Priority of the guaranteed ad. For example, the value of the guaranteed ad may be adjusted upwards if it is at a higher priority level than other priority RTB and non-guaranteed ads. The value of the guaranteed ad may be adjusted downwards if it is at a lower priority level than other priority RTB and non-guaranteed ads. This technique increases the likelihood that a higher priority ad will when ad impressions over a lower priority add in cases where there is insufficient impression inventory to satisfy all the available ads.

3. Scarcity of an impression having certain attributes. A given guaranteed ad may be targeted to a combination of attributes that are rarely met (e.g., a rare combination of property, user demographics, time of day, geographic location, occurrence of an event (e.g., a specified sporting event), etc.). For example, a rare target may be men between the ages of 31-33 in Topeka, Kans., between the hours of 12 AM-4 AM. When the system identifies an impression that matches the rare combination of attributes, the value of the guaranteed ad may be adjusted upwards (e.g., significantly upwards) to increase the likelihood that it will win the rare impression. For example, the system may raise the value orders of magnitude to ensure that the guaranteed ad will win the rare impression.

4. Campaign/line item end date. In order to ensure the goal of a given campaign/line item is met, the value of the guaranteed ad may be adjusted upwards as the end date approaches (e.g., within 5 days or other determined time period before the campaign end) to increase the likelihood that the guaranteed ad will win impressions and the goal will be met. If the end date is adjusted during the campaign, the system may re-calculate an optimal delivery and dynamically adjust the ad value accordingly. For example, if the campaign length is extended a month and the total impression goal has not changed, then the average number of impressions that need to be delivered each day is decreased. Hence, in this example, the value of the guaranteed ad may decrease (possibly depending in part on other criteria, such as scarcity, priority, etc.).

5. Oversold condition. The system may be configured to detect if a given zone is oversold such that it cannot meet all the guaranteed commitments associated with the zone. If the system detects an oversold condition, the system may adjust the value of the guaranteed ad upward to a great degree to ensure that the guaranteed ad or other high priority ads are placed, rather than open market RTB ads (although optionally a relatively small number of open market RTB ads may still be placed). An oversold condition may also be detected for geographical segments (e.g., western United States) and/or audience segments (e.g., females between the ages of 22 and 29 that are interested in vacations). If the system detects that two or more guaranteed ads that have the same priority are competing for the same impression, optionally the system will access the respective campaign values from memory, and will cause the ad with the higher campaign value to be served. As discussed elsewhere herein, a user, such as a seller of impressions, may assign different campaigns or campaign line items different priorities, wherein if there is a tie between two or more ads, the relative priorities may be used to determine which ad will win the impression. In addition or instead, the user may assign different campaign values to be used in breaking such ties, where there may be more granularity to campaign values (e.g., thousands, millions, or a virtually infinite number of values), as compared to the granularity of priority levels (e.g., where there may be 5-100 priority levels).

6. Seller preference. The system may enable the seller to specify a preference with respect to one or more modes of handling guaranteed ads. For example, one mode may be configured to enhance revenues from selling ad impressions (sometimes referred as an aggressive mode), another mode may be the traditional sequential, waterfall process (which will better ensure that guaranteed ad campaigns will meet their goals), while another mode (a “balanced mode”) may be a combination of the certain properties of the other modes. If the seller specifies the enhanced revenues mode, then the system may enable guaranteed ads to compete for the seller's impressions via the open RTB platform, rather than simply satisfying guaranteed ads first, and only afterwards letting non-guaranteed ads compete for an impression via the RTB platform. If the seller specifies the traditional sequential mode, then the system may prevent guaranteed ads from competing for the seller's impressions via the open RTB platform and will instead first satisfy any corresponding guaranteed campaign ads before instituting an RTB auction for an impression. If the seller selects the balanced mode, then the system may enable guaranteed ads to compete for the seller's impressions via the open RTB platform as in the enhanced revenues mode, unless an oversold condition is detected, in which case the sequential, waterfall process may be used.

7. Time Zone. Typically, a campaign ends at midnight of a given day. If a given ad is targeted to a particular geographical area in a particular time zone, on the final day of the campaign the system will take the time zone of the geographical area into account. Thus, for example, if a targeted time zone is 10 hours ahead of the time zone the system is utilizing, the system will treat the final day of the campaign as having only 14 hours to account for the time difference (24−10=14). If the system detects that a campaign has not meet its goals by the last day, the system may adjust the value of the guaranteed ad upwards, where the shorter the “day” the greater the upwards adjustment to better ensure the guaranteed campaign meets its goal by the end of the short “day.” This reflects the shorter period of time available to meet the goal.

8. Late Start. Ad campaigns frequently start later than the specified start date. Such a late start date may result from late delivery of ad creatives by way for example. If an ad campaign starts later than the specified start date (e.g., 1, 2, or 3 days late), the daily goals may be adjusted slightly upwards to compensate for the late start, and the value of the guaranteed ad may be adjusted upwards so that it will win a corresponding amount of additional daily impressions. For example, if the ad campaign started one day late, the system may increase the daily goal for the remainder of the month by about 3.3% and may adjust the value of the guaranteed ad upwards to win an additional 3.3% impressions a day. Optionally, the “catch up” may be front-loaded (e.g., the daily goal increase attributed to the late start may be set higher the first half of the campaign than the second half of the campaign). Optionally, the system will not further adjust the daily goals if the recent rate of delivery is projected by the system to achieve the desired delivery before a specified amount/percentage of remaining time is reached (e.g., 50% of remaining time).

9. Current over-delivery or under-delivery. If there is an over-delivery condition, the algorithm may adjust the value of the guaranteed ad downwards to decrease the number of impressions, to thereby bring the delivery of impressions closer to the optimized delivery schedule. Similarly, if there is an under-delivery condition, the algorithm may adjust the value of the guaranteed ad upwards to increase the number of impressions, to thereby bring the delivery of impressions closer to the optimized delivery schedule. The amount or percentage of the adjustment may be based at least in part on the amount or percentage of under-delivery or over-delivery and the amount of time left in the guaranteed ad campaign based on the end date.

10. Specifically identified anticipated traffic spikes (e.g., associated with a scheduled sporting event or conference). For example, a campaign may specify that a certain number or percentage of available impressions are to be served during a specified time period, such as during specified hours on a specified day. Thus, the system may adjust the value of the guaranteed ad upwards so that it will be served more impressions during the specified time period.

11. Known historic traffic patterns. For example, the system may be programmed with an indication that impressions in a certain targeted geographical area are much more available during weekday mornings, and so may adjust the value of the corresponding guaranteed ad upwards during weekday mornings (e.g., between 7 AM-11:59 AM in the local time of the geographic area) so that it will be served more impressions during that period.

It is understood that some coexisting conditions may tend to increase the adjusted value, while other coexisting conditions may tend to decrease the adjusted value. For example, an approaching end date may tend to increase the adjusted value of the ad. However, if, as the end date is approaching, the campaign has over-delivered (but has not yet reached its total goal), that may tend to decrease the adjusted value of the ad. The system may weight different conditions differently and may dynamically calculate and modify the adjusted value as conditions change. Thus, by way of illustration, in the foregoing example, even if it is likely that the overall goal will be met even without increasing the adjusted value of the ad, nonetheless, the value may be adjusted upwards to provide a very high confidence level that the goal will be met.

Thus, for example, a formula for calculating a value adjustment factor may be in the form of:

$$WHILE t > A AND t < Ω DO$$

$${P}_{t} := \frac{( t - A )}{( Ω - A )}$$

$$IF \frac{( {p}_{t} - {P}_{t} )}{\frac{{hP}_{t}}{t - A} - ( {p}_{t} - {p}_{t - h} )} > \frac{Ω - t}{2 ( Ω - A )} OR \frac{( {p}_{t} - {P}_{t} )}{\frac{{hP}_{t}}{t - A} - ( {p}_{t} - {p}_{t - h} )} < 0 THEN$$

$${δ}_{t + h} := {δ}_{t} + \frac{λ {δ}_{t} ( 1 - \frac{{p}_{t}}{{P}_{t}} )}{1 - {P}_{t}}$$

$$ELSE$$

$${δ}_{t + h} := {δ}_{t}$$

$$ENDIF$$

$$t := t + h$$

$$ENDWHILE$$

$${δ}_{k} \text{:} Guaranteed Campaign OCPM at time k$$

$$t \text{:} Time , quantized$$

$$h \text{:} Time quantization ( e . g . , 5 minutes or other “ tick ” )$$

$$A \text{:} Campaign start time$$

$$Ω \text{:} Campaign end time$$

$${ρ}_{k} \text{:} Campaign fulfillment ( \frac{\begin{matrix}“ successfully delivered impressions \\ at time k ”\end{matrix}}{“ total contractual impressions ”} )$$

Several illustrative examples will now be provided.

### EXAMPLE 1

An ad impression is available. A guaranteed ad associated a guaranteed ad campaign is at normal priority with a contract price of $5. The guaranteed ad campaign pacing is at 90% of the campaign goal. Based on the contract price and the current pacing, the oCPM has been adjusted by the algorithm downwards to $2 (reflecting the high likelihood that the guaranteed ad campaign goal will be met even if the guaranteed ad campaign ad does not win the current ad impression).

An open market bid is received at $4. The system compares the open market bid of $4 against the adjusted guaranteed ad oCPM of $2, and determines that the open market bid is higher. Therefore, the system determines that the open market bid wins the impression, and serves the open market bid the ad accordingly, even though it is lower than the guaranteed ad contract value.

### EXAMPLE 2

An ad impression is available. A guaranteed ad associated with a guaranteed ad campaign is at normal priority with a contract price of $5. The guaranteed ad campaign pacing is at 10% of the campaign goal. Based on the contract price and the current pacing, the oCPM has been adjusted by the algorithm upwards to $10 (the increased adjusted oCPM reflecting the anticipated difficulty in meeting guaranteed ad campaign goal).

An open market bid is received at $4. The system compares the open market bid of $4 against the adjusted guaranteed ad oCPM of $10, and determines that the adjusted guaranteed ad oCPM is higher. Therefore, the system determines that the adjusted guaranteed ad oCPM wins the impression, and serves the guaranteed ad accordingly.

### EXAMPLE 3

An ad impression is available. A guaranteed ad associated with a guaranteed ad campaign is at normal priority with a contract price of $5. The guaranteed ad campaign pacing is at 50% of the campaign goal. Based on the contract price and the current pacing, the oCPM has been adjusted upwards to $5.50. The zone has been flagged PMP Private (private market place), and so open market bids are not gathered. A PMP Private bid comes in at $6 with low priority. The guaranteed ad competes with the PMP Private at the same tier and priority.

The system compares the PMP Private bid of $6 against the adjusted oCPM of $5.50, and determines that the adjusted oCPM is lower. Therefore, the system determines that the PMP Private bid wins the impression, and serves the guaranteed ad accordingly.

### EXAMPLE 4

An ad impression is available. A first guaranteed ad associated with a first guaranteed ad campaign is at normal priority with a first contract price of $8. The first guaranteed ad campaign pacing is at 90% of the campaign goal. Based on the first contract price and the current pacing, the first contract oCPM has been adjusted to $3, reflecting the high likelihood it will meet its campaign goal even if it does not win the impression.

A second guaranteed ad associated with a second guaranteed ad campaign is at normal priority with a second contract price of $8. The second guaranteed ad campaign pacing is at 50% of the campaign goal. Based on the second contract price and the current pacing, the second contract oCPM has been adjusted to $6.

An open market non-guaranteed ad has a value price of $6.

A First Right bid of $6 is received from a DSP at normal priority.

The non-guaranteed ad is excluded from the First Right priority.

The system determines that the second contract oCPM of $6 and the DSP bid are tied. The system randomly selects the winner from the second non-guaranteed ad and the DSP, and serves the impression accordingly.

This technique enables a greater number of ad impressions to be sold via real-time bidding (e.g., at higher prices) as compared to the conventional waterfall technique, while still ensuring that guaranteed ads are placed in a manner that satisfies the corresponding guarantees. Thus, revenues may be enhanced while still meeting campaign goals.

Certain aspects will now be discussed with reference to the figures, which illustrate example aspects.

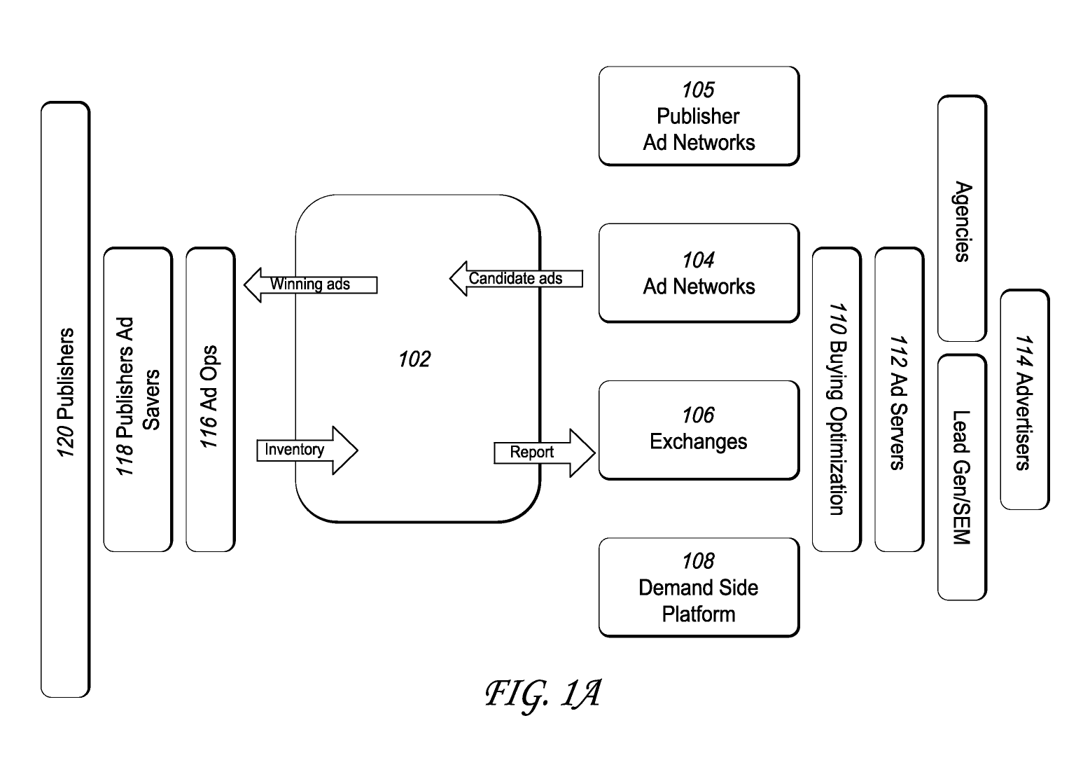

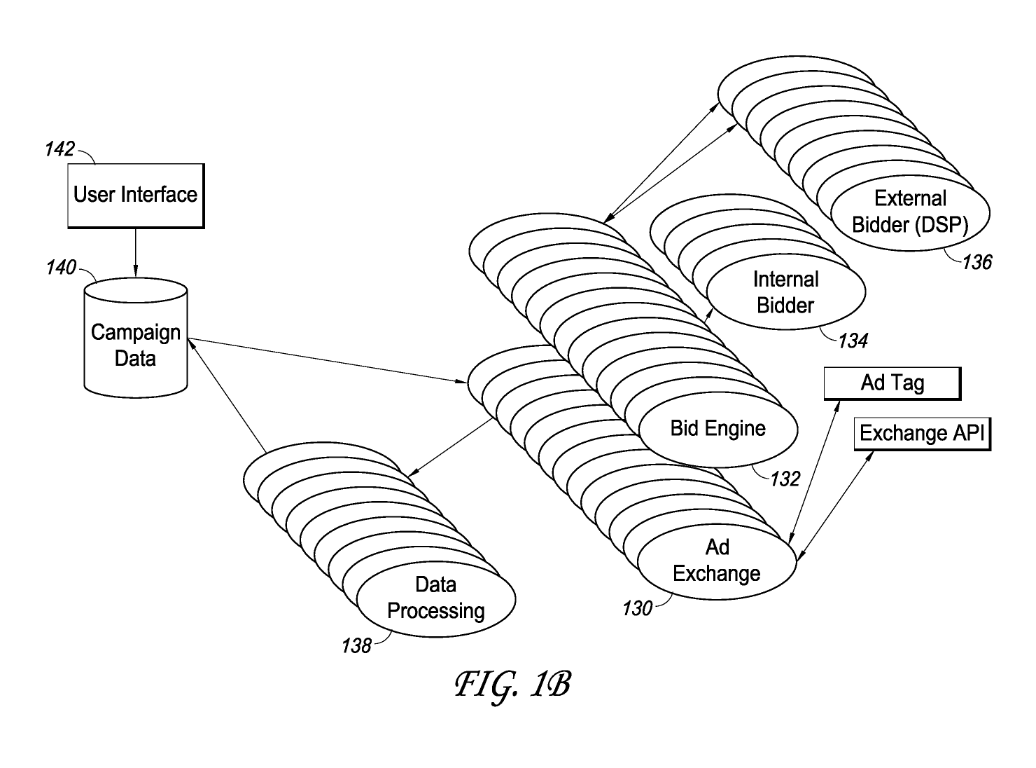

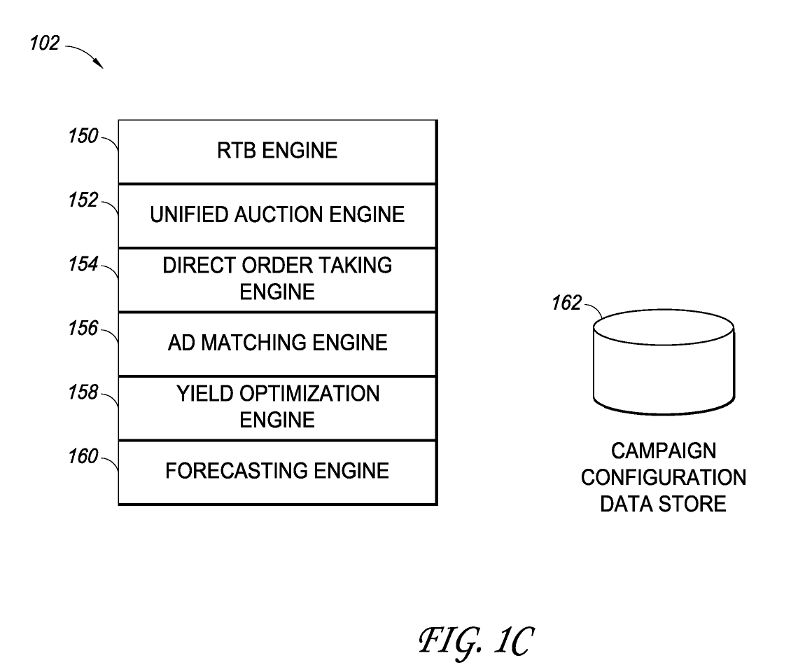

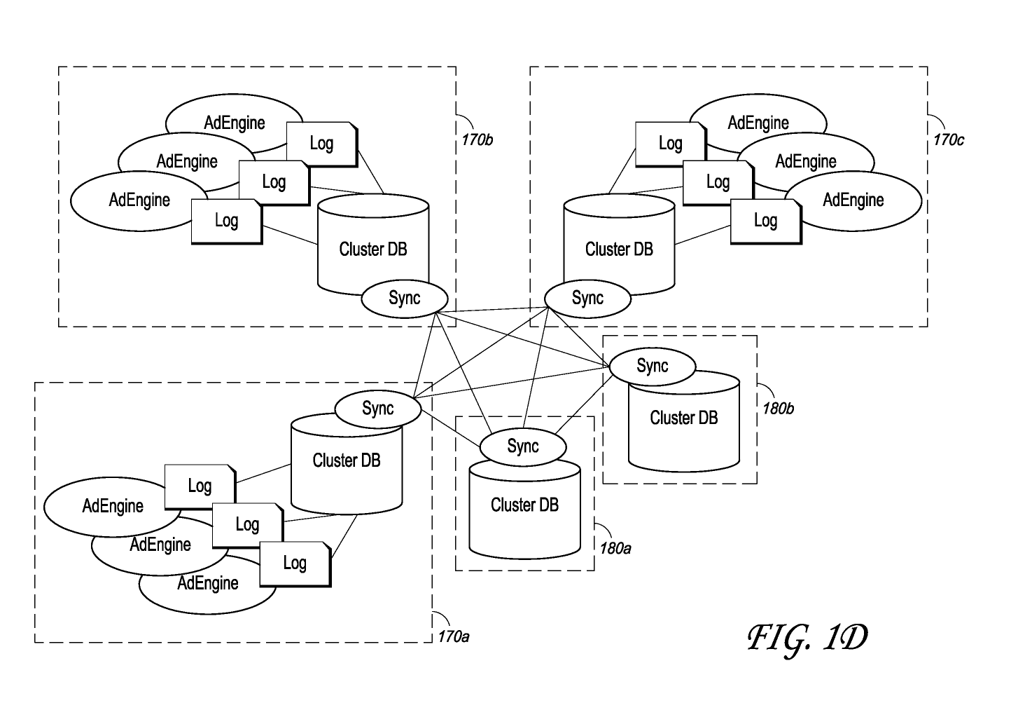

FIG. 1A illustrates an example architecture which may be utilized to execute processes described herein. The architecture may comprise an automation cloud 102. With reference to FIG. 1C, the automation cloud 102 may include some or all of the following: an RTB platform engine 150, a unified auction engine 152 configured to execute a unified auction such as that described elsewhere herein, a direct order taking engine 154 configured to receive execute direct-sold advertising deals, an ad matching engine 156 configured to match ads (or other third party content) to page content, a yield optimization engine 158, a forecasting engine 160, and a campaign configuration data store 162 that stores campaign configuration files. Certain components, such as the unified auction engine 152 (which corresponds to the RTB engine 132 illustrated in FIG. 1B), may be run time components, while other components may be executed periodically, in a batch mode.

The example automation cloud 102 may be configured to process trillions of transactions a month in substantially real-time. For example, certain embodiments of the automation cloud 102 may include thousands of processors (e.g., 25,000 or more processors) and a high speed transit network (e.g., 260 Gbytes or higher transit network). The automation cloud 102 may be configured with more than 2 Petabytes of data processing throughput to enable large amounts of transactions to be processed at high speed (e.g., millions of bid transactions, such as bid requests, a second) and with high reliability. The automation cloud 102 may include servers distributed over a wide geographic area, such as in multiple continents so that the delivery of ad impressions may be performed in a fraction of a second. Other example automation clouds may have fewer or greater numbers of processors, lower or higher speed transit networks, and more or less processing power. The various components may be managed via a distributed, decentralized management system, comprising distributed nodes. Thus, if a single node fails, the system may continue operating, thereby enhancing system reliability and accessibility.

The automation cloud 102 may be configured to interface with and process bids from large numbers of buying platforms (e.g., more than 100, more than 300, or more than 1,000 buying platforms, which may comprise one or more servers) and to process the bids faster than publisher systems can fully serve webpages on which ads will be placed. For example, the automation cloud 102 may include network and software interfaces configured to receive ad candidates from ad networks 104, publisher ad networks 105, ad exchanges 106, and/or demand side platforms 108. For example, the ad candidate information may include bid amounts, creatives, and other information. Bids may be generated via buying optimization systems 110, which may service advertisers 114, agencies, and/or search or engine marketing (SEM) lead generation entities. Ad serving systems 112 associated with one or more ad serving entities may host and serve ads for advertisers, agencies, etc.

The automation cloud 102 may be configured to interface with various inventory sources, such as publishers 120, which may be associated with publisher ad servers 118 and ad operation systems 116. Winning ads may be provided to the inventory sources for display on user terminals. The automation cloud may transmit reports to various advertisers as to which of their ads won, how much they were charged, on which properties the ads were delivered, etc.

Referring to FIG. 1B, an example automation cloud system architecture is illustrated. An ad exchange system 130 includes large numbers of ad exchange clusters that enable advertisers and publishers to buy and sell advertising impressions, such as via real-time auctions. An exchange API enables buyers to submit bids and creatives to the ad exchange system 130. The ad exchange system 130 also receives ad tags. A bid exchange system 132 includes large numbers of bid engine clusters that process bid requests and transmit bid responses to the ad exchange system 130. The bid engine system 132 may interface to external bidder systems 136 (e.g., DSPs) and internal bidder systems 134. The ad exchange system 130 interfaces to a data processing system 138. The data processing system 138 may include clusters providing distributed storage and processing, such as for storage of log files for the ad-related transactions discussed herein. The ad exchange system 130 and data processing system 138 may be networked to a campaign database 140 that stores some or all of the campaign related data discussed herein. One or more user interfaces 142 are provided enabling a user to enter campaign setup data.

With reference to FIG. 1D, the automation cloud may comprise one or more highly scalable networked clusters providing distributed storage and processing, such as for storage of log files for the ad-related transactions discussed herein (e.g., logs of the sale of impressions, the contractual monetary value of ad impressions, the effective auction value of ad impressions, etc.). In addition to being used to conduct a unified auction, the data collected by the illustrated system may be utilized to determine how much to bill clients or how much is owned to clients.

For example, an automation cloud system may comprise a plurality of servers that may be distributed in a plurality of datacenters 170a, 170b, 170c, 180a, 180b, in different geographic regions, such as in different regions, countries, and continents to provide global coverage. The datacenters may log and share data with each other to provide a global view of ad delivery and to enhance reliability and data availability. The logged data may be stored by one or more local log data servers. Certain datacenters, such as datacenters 170a, 170b, 170c, may also include one or more ad engines that may host the unified auction platform discussed herein, permitting open market ads to compete with guaranteed ads for a given impression. Other datacenters, such as datacenters 180a, 180b, may not include an ad engine. A given ad engine may also execute the pacing process discussed herein.

The distributed storage and processing system may be configured to provide automated failover for critical services in the event of one or more system failures, thereby preventing or limiting service disruption. The illustrated networked datacenters may be configured to process and store enormous amounts of data, including structured, unstructured and semi-structured data.

An example technique of data synchronization will now be described. Ad serving data (e.g., logs of the sale of impressions, the contractual monetary value of ad impressions, the effective auction value of ad impressions, other data discussed herein, etc.) on each server may be summarized by a cluster master process and inserted into a local cluster database. Each cluster database may then be replicated across selected or all other clusters by respective synchronization services, with appropriate validation and monitoring. The synchronization service may push the data of its datacenter to other datacenters. Thus, optionally, a centralized system that controls the data synchronization process is not used, thereby avoiding a single point of failure with respect to the synchronization process.

The synchronization process enables the pacing algorithm running in each cluster to have access to recent data providing a recent view of how other clusters have delivered a given ad, and thus how the ad has served globally. In this way, the pacing algorithm accesses the needed or desirable information to adjust the rate of ad delivery up or down as required. The synchronization process may be performed periodically (e.g., in substantially real time, every one minute, every 5 minutes, every hour, twice a day, once a day, etc.).

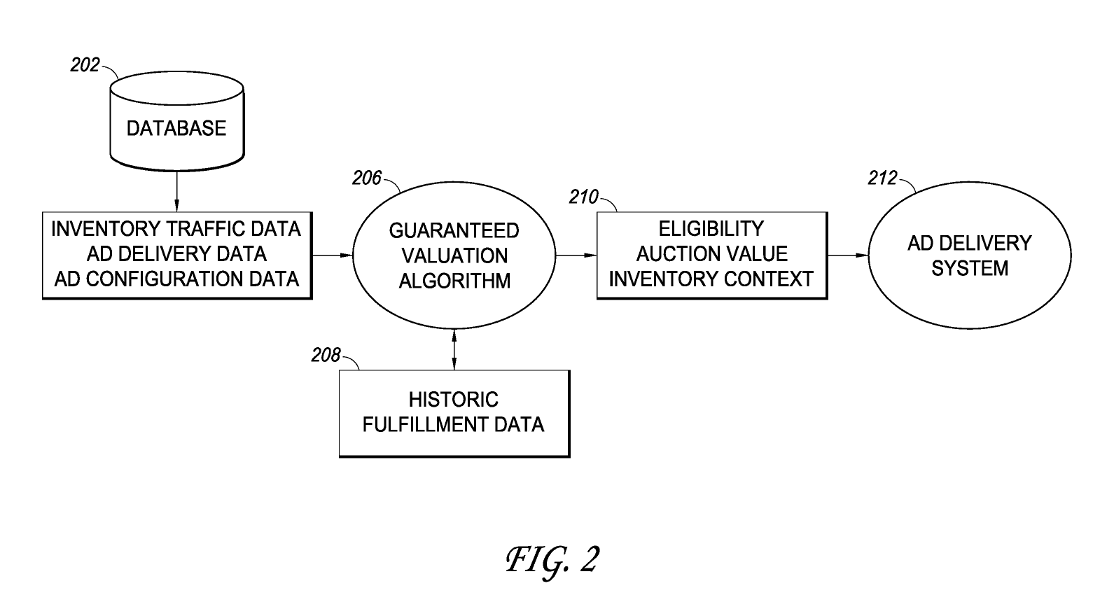

Referring to FIG. 2, an example process is illustrated that may be executed using an automation cloud. The system accesses, from one or more data stores 202, 206, data including some or all of the following: inventory traffic data, ad delivery data, ad configuration data, and historic fulfillment data. The data may be processed using a guaranteed valuation algorithm 206, which generates an oCPM for a given guaranteed ad. The oCPM, as well as other factors (e.g., eligibility, inventory context, and/or other factors such as those discussed elsewhere herein) may be used by an engine 210 to determine a winning ad. An ad delivery system 212 causes the winning ad to be delivered. The foregoing features are discussed in greater detail below.

The inventory traffic data may include recent and older historic site traffic information (e.g., number of unique visitors per day or other time period, number of page views, etc.), and certain site attributes, such as user characteristics (e.g., user demographics, user access patterns, etc.), geographic characteristics (e.g., the geographic areas the site is targeted to), language, etc. Optionally, inventory traffic may include inventory traffic projections (e.g., generated using the forecasting engine 160) and/or seller-provided information regarding anticipated traffic patterns (e.g., the seller's site will be presenting content of high interest on a certain date, and the seller provides information regarding anticipated resulting spikes in users accessing the site).

The ad delivery data may include recent and older historic ad pacing information indicating the historic serving of ads over a schedules time period.

The ad configuration data may include information indicating which ads are scheduled to run for a specified time or time period, and over what type of traffic.

The following is a set of example configuration data:
‘pm.guaranteed.ramp_point’: 0.2, # start end date push when 20% of time remains
‘pm.guaranteed.ramp_push’: 2, # magnitude of end date push
‘pm.guaranteed.min_ocpm’: 0.01, # lowest possible dynamic value
‘pm.guaranteed.max_ocpm’: 1000, # highest possible dynamic value
‘pm.guaranteed.min_pace’: 0.01, # lowest possible ‘eligibility’
‘pm.guaranteed.pace_conversion_rate’: 1.2, # rate at which eligibility is converted to price
‘pm.guaranteed.priority_ocpm_delta’: 10.00, # cap difference ($) per priority level
‘pm.guaranteed.delta_multiplier’: 1.0, # how strongly to react to being off schedule
‘pm.guaranteed.pct_oversold_threshold’: 0.8, # when to consider a zone oversold
‘use_effective_start_date’: True # consider the first date of actual delivery

The foregoing example ad campaign configuration data specifies a start date and magnitude for rear-loading (also referred to as an end-date push). In addition, the lowest and highest permissible dynamic values are specified for the oCPM. For example, there may optionally be a cap on an effective auction value which will limit how much it can be adjusted upwards. The cap may be based on priority and an agreed upon contract price. For example, higher priority and value ads may optionally tend to have relatively higher auction caps.

The configuration data also specifies the lowest permitted eligibility and the rate at which eligibility is converted to price. Eligibility, sometimes referred to herein as “pace”, indicates how often a given ad should be considered for delivery. For example, the pace may specify a percentage of auctions the ad is eligible to compete in. Ideally, the eligibility for a given ad may be 100% to ensure competition for each impression and to enhance revenues. However, it may be desirable to lower or raise the eligibility/pace to smooth the ad delivery. Thus, the system may generate eligibility for an ad based at least in part on historical and recent fulfillment metrics. The eligibility indication may be used to control how many servers should be concurrently delivering an ad. Without such control, low volume ads, and in particular low volume ads, could deliver too quickly. For example, if not moderated, there may be situations where a day's budget may be utilized by 10 AM. Eligibility adjustment may be used in combination with ad value adjustment (oCPM) to control the delivery of ads. Eligibility adjustments may provide an enhanced technique for slowing ad delivery as compared to auction value adjustment, which may at times be unable to sufficiently slow ad delivery.

As noted above, optimal revenue is typically achieved if the pace/eligibility is 100%. If the pace has been reduced to below 100% (e.g., to slow serving of impressions of an ad), at an appropriate time the pace may then be slowly increased (e.g., by a multiplier specified in a configuration file), and the oCPM may be decreased by about the same ratio. This enables the increase in pace to be balanced out by the decrease in oCPM, so that delivery is not significantly impacted. By way of illustrative example, if the current pace is 60% and the oCPM is $1.50, the pace may be adjusted upwards to 72%, and the oCPM pace and oCPM may be adjusted downwards to $1.25. The adjustments may be incrementally performed at each iteration or tick of the algorithm (e.g., every 1 minute, every 5 minutes, or other time increment) until the pace is about 100%.

The maximum permitted oCPM delta between different priority levels is also specified in this example. The configuration data specifies how strongly the algorithm is to react to being off the ideal delivery schedule with respect to over-delivery or under-delivery situations. In this example, higher values adjust the oCPMs to a relatively greater degree (to bring the delivery closer to the ideal delivery schedule more quickly), smaller values adjust the oCPMs to a relatively lesser degree (to bring the delivery closer to the ideal delivery schedule more slowly). In addition, the configuration data specifies what date is to be used as the first date of actual impression delivery for the campaign.

The inventory traffic data, ad delivery data, and ad configuration data may be received by a valuation algorithm, which may be executed by a yield optimization engine, such as that illustrated in FIG. 1B. The algorithm may also generate or receive a delivery schedule, which may be optimized to ensure certain goals are met (e.g., daily delivery goals, overall delivery goals, smooth delivery goals, front loading goals, etc.). The optimized delivery schedule may be linear, linear in part and non-linear in part, or completely non-linear.

For example, the optimized delivery may be front-loaded and/or rear-loaded, where higher than average impressions are served at the beginning of the campaign and at the end of the campaign, and where lower than average impressions may be served at one or more points during the campaign. By way of further example, the delivery schedule may anticipate periods of low inventory (e.g., forecasting using the forecasting engine, based on historical information, the occurrence of a specific event (e.g., a sporting event), and/or based on information provided by the seller/publisher), and so may compensate by serving more impressions to the ad during periods where there is anticipated adequate inventory. The delivery schedule may be rendered via a user device for display to a user.

The valuation algorithm may calculate an estimated effective auction value (e.g., the oCPM) for a given ad based on the inventory traffic data, ad delivery data, ad configuration, and/or delivery schedule. The algorithm may also receive historic fulfillment and output values, which provides feedback to the algorithm indicating whether previous value adjustments have achieved the desired level of ad delivery, and adjust the effective auction value accordingly to achieve the goals. Thus, the algorithm may incorporate a feedback loop to adjust the oCPMs to meet a desired delivery curve. The algorithm may output eligibility information, an effective auction value, and inventory context.

As similarly discussed above, the adjusted effective auction value, or oCPM, is an effective monetary or other value for a given guaranteed ad in the context of a real time auction that may involve both guaranteed and non-guaranteed ads. For example, the effective auction value may be an upward adjustment in a contract value for a guaranteed ad if the guaranteed ad campaign is behind schedule and is currently under-delivering. By way of further example, the effective auction value may be a downward adjustment in a contract value for a guaranteed ad if the guaranteed ad campaign is ahead of schedule and is currently over-delivering. As discussed elsewhere herein, other factors, such as priority, scarcity, end date, seller preference, time zone, anticipated traffic spikes, known traffic patterns, and/or other factors may be utilized in calculating the oCPM.

Inventory context indicates to the system whether guaranteed ads in a given area are in an oversold scenario. For example, as discussed elsewhere herein, some sellers may prefer conservative behavior when an area is overcommitted and so may want to revert to a sequential, waterfall approach in the event the system detects an oversold condition to better ensure that the guaranteed ads will meet their campaign goals, even though revenue may be lost by not having guaranteed ads compete against open market auction bids for the impression.

The valuation algorithm may be used to adjust the pace and/or effective auction value up or down based on one or more of the following example rules. The valuation algorithm may calculate, for a given ad, the ad's desired fulfillment (e.g., what percent of the total lifetime goal should be served at the current time). The system may also calculate the given ad's current actual fulfillment based on recent delivery information. The system may lookup recent fulfillment history for the ad. Based on some or all of the foregoing, the valuation algorithm may determine if the recent rate of change in actual fulfillment is projected to bring the ad to the desired fulfillment within a specified time frame. If the determination indicates that the recent rate of change in actual fulfillment is projected to bring the ad to the desired fulfillment within a specified time frame, then the system may elect not to adjust the pace or effective auction value. If the determination indicates that the recent rate of change in actual fulfillment is not projected to bring the ad to the desired fulfillment within a specified time frame than the pace and/or effective auction value may be adjusted accordingly to speed or slow the rate of change.

For example, if the ad is at or close to the specified desired fulfillment and the recent rate of change would cause the delivery to overshoot the desired fulfillment, the valuation algorithm may decrease the pace and/or the ad's effective auction value. If the ad is at or close to the specified desired fulfillment and the ad the recent rate of change would cause the system to undershoot the desired fulfillment, the valuation algorithm may increase the pace and/or the ad's effective auction value. If the ad is far from the specified desired fulfillment and the recent fulfillment history does not show progress towards reaching the desired fulfillment, the system may increase the pace and/or the ad's effective auction value. Optionally, changing the pace may be only or primarily used for slowing the delivery of an over-delivering ad.

Optionally, the valuation algorithm may be configured to receive a specified milestone date (e.g., as a specified number of days before the end of an ad's schedule). The algorithm may be configured to raise the valuation or pace near the end of the date range by a configurable percent (e.g. 10% more aggressive in the last 3 days), or alternately to aim for completion a configurable amount of time sooner. (e.g. aim to finish at noon on the last day instead of midnight of the last day) to increase the likelihood that the ad will meet its overall impression goal.

Thus, as similarly described elsewhere herein, in order to ensure that a guaranteed ad wins a unified auction when it is significantly behind its associated impression fulfillment pace, the system may significantly increase its effective auction value (e.g., from $5 to $500). However, when logging and reporting the sale of the impression, the system may report both the contractual monetary value and the effective auction value, or just the contractual monetary value.

Thus, for example, configuration files may be transmitted to ad engine processes executing in one or more automation cloud 102 servers. The configuration files may include auction rules for a given account/site/zone/size combination which determine which ads may participate in an auction and which RTB networks are allowed. The desired pace and capped status of each ad may be periodically (e.g., every minute, every 5 minutes, every 15 minutes, or other time period) determined. The system may also dynamically calculate an adjusted ad value of direct guaranteed line items based on how well the ad placement is performing with respect to its daily goal, targeting details, and/or other factors. Dynamic price floors may be calculated periodically to enhance/optimize a seller's revenue.

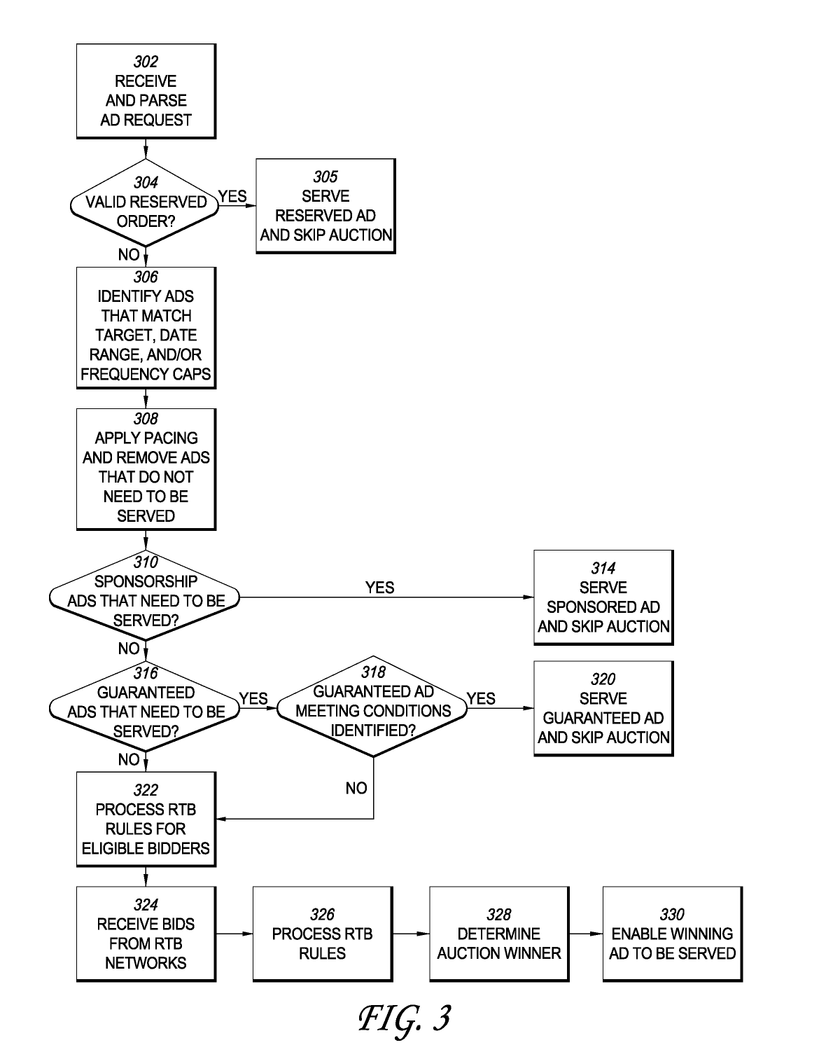

An example process for processing an ad request in the context of a unified auction will now be described with reference to FIG. 3. At block 302, the ad request is received and parsed. For example, the request may be received from a user browser displaying a webpage or from an exchange API. At block 304, a determination is made as to whether the request is for a valid “reserved order”, which has reserved specified inventory. At block 305 the process enables the reserve order ad to be placed, and the auction may be skipped.

If a determination is made that there is not a reserved order, at block 306 ads that match targets, date range, and/or frequency caps (e.g., specifying the maximum number of times an ad may be served in a given time period, such as a day) are identified. Those ads that fail to match may be removed from consideration with respect to the ad request. At block 308, pacing is applied to the ads remaining for consideration to determine which ads are eligible to participate in an RTB auction.

At block 310, a determination is made as to whether sponsorship ads are available for the impression. If sponsorship ads are available, then a share-of-voice percentage may be applied (e.g., where each ad is provided a substantially equal percentage of the available impressions). If a tie is detected between two or more sponsorship ads' bids, the winner may be randomly selected between the tied bids. At block 314, the sponsored ad is served, and the auction may be terminated.

If a valid sponsorship ad has not been received, at block 316 a determination may be made as to whether there are any available guaranteed ads for the ad request. If there are guaranteed ads available for the ad request, a determination is made at block 318 as to whether a guaranteed ad is to be selected without conducting an auction. For example, if a traditional sequential, waterfall process has been specified, at block 320, the guaranteed ad is served and the auction is skipped. On the other hand, if a balanced mode is selected (and a determination is made that there is not an oversold condition), or a revenue enhance mode is selected, as discussed elsewhere herein, then the oCPM for the guaranteed as is accessed from memory, and the process proceeds to block 322.

At block 322, the real-time bidding rules for eligible bidders are accessed and processed to determine which RTB networks are eligible to compete in an RTB auction. At block 324, bids are received from the eligible RTB networks. At block 326, the RTB rules are processed. At block 328, an auction winner is determined. For example, an oCPM of a guaranteed ad may be compared with an open market RTB to determine which has a higher value, and the higher value wins. If there is a tie, the winner may be selected randomly, or otherwise (e.g., the guaranteed ad may be selected, or the open market real time bid advertisement may be selected). At block 330, the selected winning ad is served.

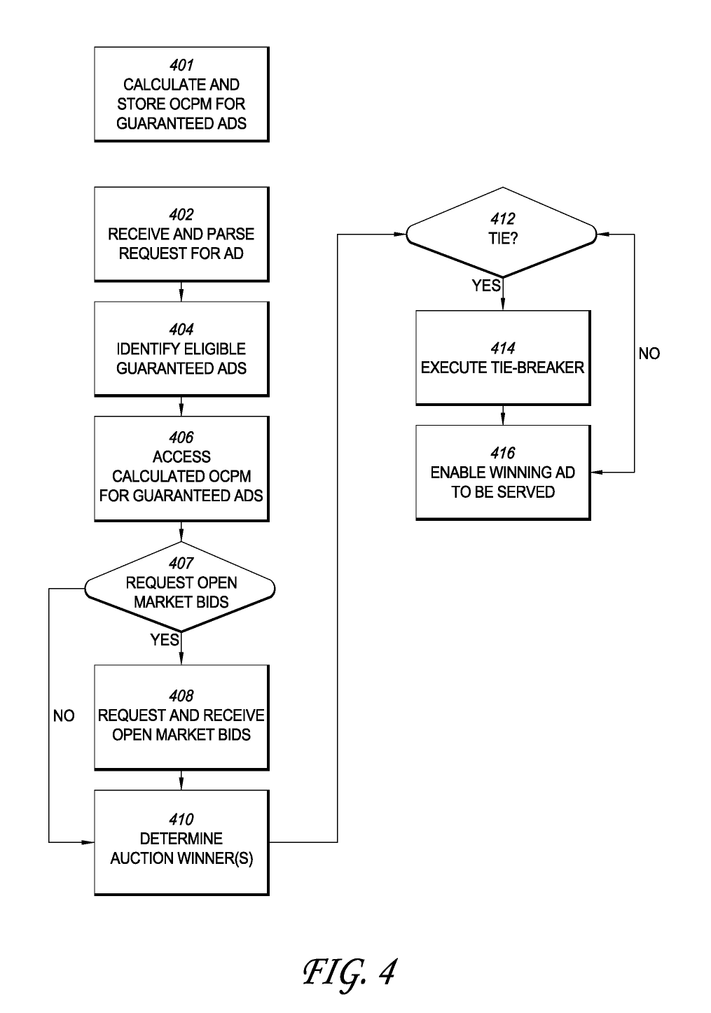

FIG. 4 illustrates another example process, simplified relative to the process illustrated in FIG. 3. At block 401, oCPMs are calculated for one or more guaranteed ads. The calculations may be performed periodically (e.g., in batch mode, every minute, every 5 minutes, every 10 minutes, or otherwise) or in real time in response to a request for bids. At block 402, an ad request is received and parsed. For example, the request may be received from a user browser or other user agent displaying a webpage or from an exchange API. At block 404, pacing is applied and the process identifies eligible guaranteed ads (e.g., based on pace and/or one or more targeting criterion, such as one or more of property targeting, user demographics targeting (e.g., gender, age, income, etc.), time of day targeting, geographic location targeting, occurrence of an event targeting, behavioral targeting (e.g., past behavior of the user (network traffic of the user, searches, site visits, purchases, etc.), etc., which may optionally be combined into a targeting vector). Ads that are not determined to be eligible may be excluded from the RTB auction and may not be used to respond to the ad request. At block 406, the calculated oCPMs for the eligible ads are accessed from memory. At block 407, a determination is made as to whether open market bids should be requested. If the determination indicates that open market bids are to be requested, then the process transmits, at block 408, open market bids requests are transmitted to RTB networks eligible to compete in an RTB auction, and bids are received from the RTB networks.

At block 410, auction winner(s) are determined. For example, an oCPM of a guaranteed ad may be compared with an open market RTB to determine which has a higher value, and the higher value wins. At block 412, a determination is made as to whether there are tied winners for the impression. If there is a tie, at block 414, a tie breaker routine is executed. For example, the winner may be selected randomly from the tied winners, or otherwise (e.g., the guaranteed ad may be selected, the open market real time bid advertisement may be selected, or value prices specified by a user may be utilized where the ad with the higher value price is selected to win). At block 416, the selected winning ad is served.

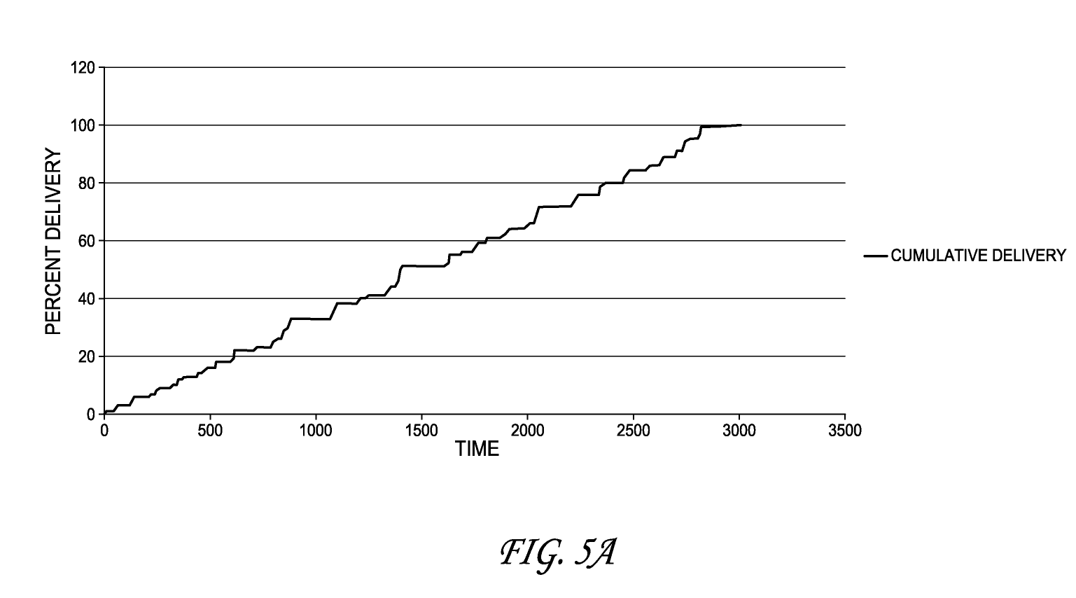

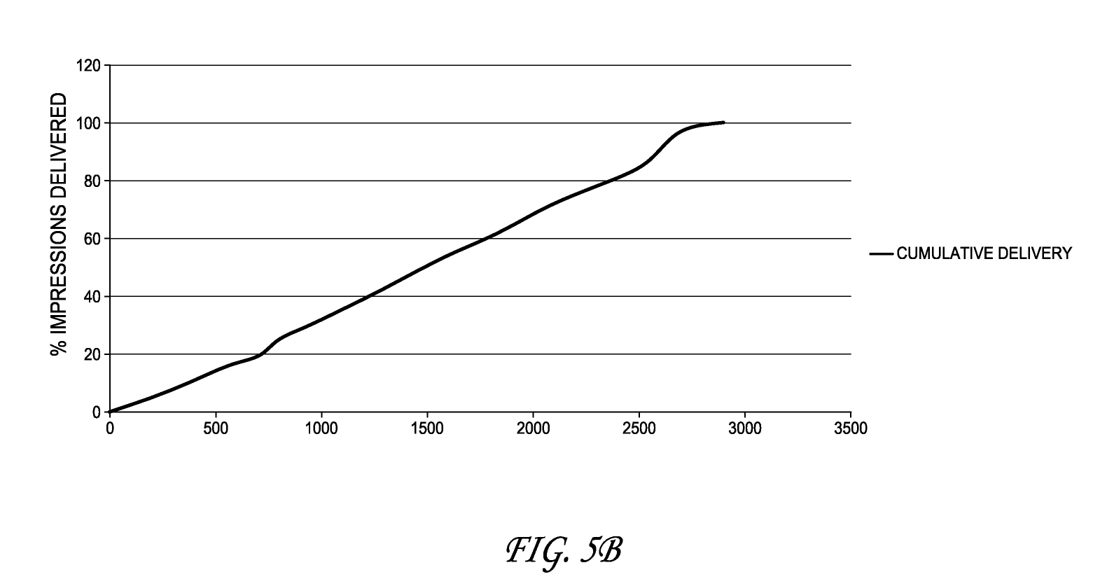

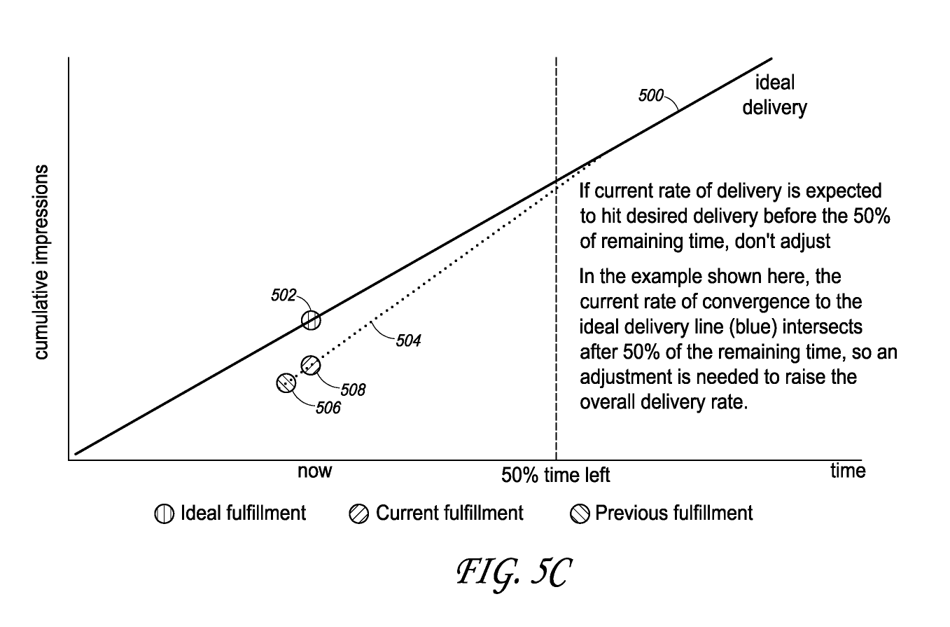

FIGS. 5A-5C illustrate example delivery curves.

FIG. 5A illustrates a significantly non-optimal ad delivery curve, with sharp spikes and periods of non-delivery. The Y-axis corresponds to the percent of the impressions delivered with respect to the total impression goal, and the X-axis corresponds to time.

FIG. 5B illustrates an example optimized cumulative delivery schedule curve which may be generated by the system for a given campaign line item. In this example, the impression delivery is configured to be fairly smooth and fairly linear over the campaign time period, with rear-loading towards the campaign end to ensure that the campaign goal is met. The optimized cumulative delivery schedule curve may be generated based on one or more of the factors discussed herein, such as the start date, the end date, forecast traffic patterns, specifically identified events associated with desirable inventory, etc.

FIG. 5C illustrates a scenario where the guaranteed ad campaign started late, and so the system needs to catch-up on impressions for the guaranteed ad. Curve 500 is an ideal delivery curve for the ad, which may be generated by the system as similarly discussed above. Indicator 502 indicates the ideal cumulative impression percentage at the current point in time. Curve 504 indicates the projected cumulative impression delivery for the remaining campaign time based on the previous and current fulfillment (indicated by indicators 506 and 508, respectively). For example, the previous fulfillment may be the fulfillment 5 minutes or 30 minutes from the current point in time, while the current fulfillment may be the fulfillment within the last 1 minute or last 5 minutes. The algorithm is configured to attempt to cause the cumulative impression delivery, based on the previous and current delivery, to converge with the ideal cumulative impression delivery at the midway point of the campaign (although other campaign points may be chosen, such as one-quarter or three-quarters through the campaign).

If the system calculates and projects that the cumulative impression delivery will not converge with the ideal cumulative impression delivery at the midway point of the campaign, the system may increase the oCPM of the ad to increase the daily number of impressions it will win via the unified auction. If the system calculates and projects that the cumulative impression delivery will converge with the ideal cumulative impression delivery at the midway point of the campaign, the system may leave the oCPM unaltered.

Because the guaranteed ad campaign goals are in the form of a contracted obligation, it may be advantageous to generate reporting insights into the potential for making a given contractual ad delivery obligation. Therefore, optionally, the disclosed systems and methods may be configured to generate such reporting insights from historical information and other information, as discussed herein. For example, the reports may include impression projections for a given site, webpage, zone, geographically region, and/or audience segments over a specified period of time.

Certain example user interfaces will now be described in greater detail.

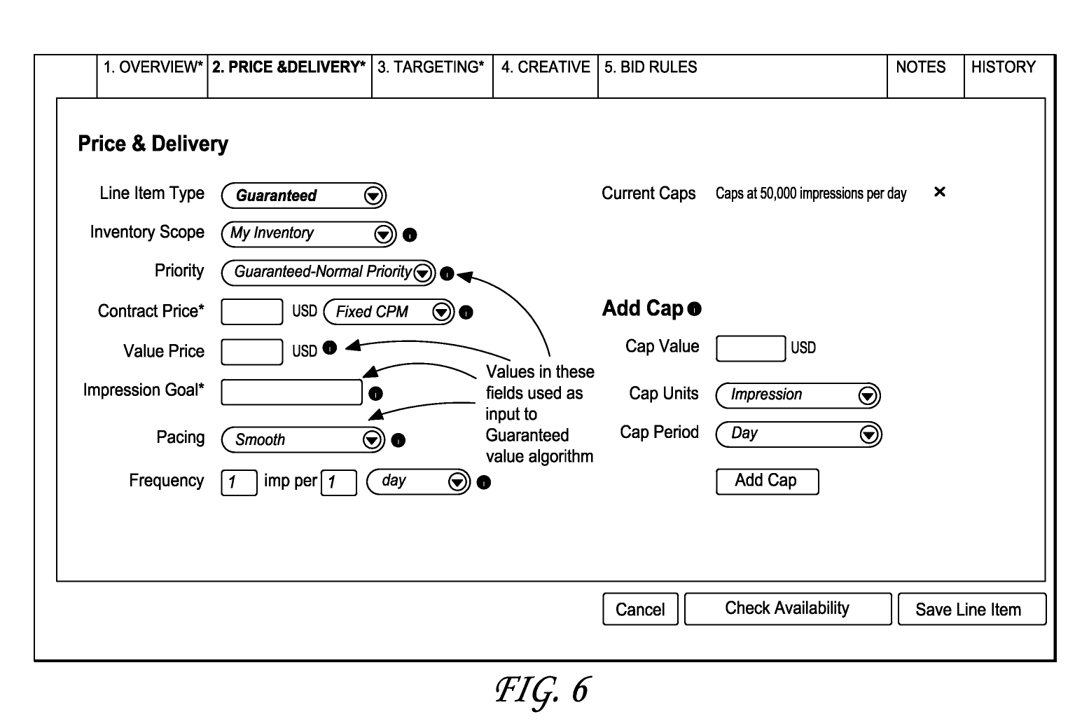

An example ad campaign user interface, such as that illustrated in FIG. 6, may enable a user to specify that an ad impression delivery is of type “guaranteed” and/or is of type “sponsorship”. The user may be a seller or other entity.

Optionally, for some purposes, (e.g., delivery, reporting, finance systems, etc.), “guaranteed” is recognized and treated as a type, and “sponsorship” as a priority (type=Guaranteed, priority=Sponsorship).

The user interface enables the user to specify the inventory scope. For example, the user can specify that the inventory is that of the user (e.g., an online property of the user) or of a third party.

The user interface may also enable the user to specify the priority of the line item. For example, there may be 3, 6, 12, 18 or other number of priority levels that may be assigned. The priority levels may be presented via a drop down menu or otherwise, and the user may select the desired priority level from the menu.

For line items of type “guaranteed,” the system may receive from the user a guaranteed impression goal, a start date, and an end date. A user interface may be provided via which the user may specify a bonus to the goal (e.g., as a percentage set per-account). Optionally, a default bonus may be used. Optionally, the user interface may enable the user to specify that the bonus may be overridden on a per-line-item basis.

Optionally, a user interface may be provided enabling the user to specify for a given guaranteed line item a contract price whether the guaranteed line item is Fixed-CPM (where the CPM is at a fixed rate) or Bidded-CPM (where the buyer bids for a set of impressions). Optionally, the user is prevented from specifying CPC (Cost per Click) or CPM-C (Cost per thousand impressions) for a guaranteed line item.

Optionally, a user interface is provided via which the user can specify a value price for the line item. The value price may be utilized to break bidding ties with greater granularity than priority, as discussed elsewhere herein. A user interface may also be provided via which the user can specify an impression goal.

Optionally, a user interface is provided via which the user can specify pacing. For example, the pacing user interface may be in the form of a drop down menu listing various pacing options, such as a “smooth” pacing option or an “as fast as possible” pacing option for an advertising campaign, instructing the system to, respectively smoothly deliver impressions or utilize every available/won impression without throttling (optionally except for delivery caps). Optionally, the system detects when the “as fast as possible” pacing option has been selected and if a cap has not been set. If the system detects that the “as fast as possible” pacing option has been selected and a cap has not been set, the system generates a warning message to the user and/or other specified users.

Optionally, a user interface is provided via which the user can specify a desired impression frequency for the line item, such as the number of impressions per a specified time period (e.g., the number of impressions a day).

Optionally, a user interface is provided enabling the user to add and specify a delivery cap for owned-and-operated (O&O) and/or other inventory. Optionally, user interfaces are not provided that enable a user to specify budget caps for O&O inventory. Interfaces are provided via which the user can specify cap value (e.g., in currency), cap units (e.g., impressions, clicks, acquisitions), and cap period (e.g., day, week, month, etc.). Optionally, a budget cap field is not provided for “guaranteed” line items.

A user interface may be provided enabling the user to set a minimum daily guaranteed number of impressions even if the impression goal has already been met. The minimum daily guaranteed number of impressions may be settable per publisher as a percent of ideal daily delivery.

The system is configured to deliver or to attempt to deliver at least the stated goal, optionally in a balanced manner. The system is configured to store and report metrics about indicating how well a given guaranteed line item is delivering.

A control may be provided which when selected causes the system to check for inventory impression availability for impressions that would satisfy the line item. For example, the system may base an availability determination on some or all of the following: beginning and end dates, number of impressions, average impressions per user, price, campaign type, frequency caps, supported targeting elements, etc.

The system is optionally configured to set a guaranteed line item at a higher priority to force additional delivery of ad impressions. The system is optionally configured to execute a “conditional priority” specified by a user via a user interface. For example, a user interface may be provided enabling the user to set a priority rule that specifies a line item, a priority level, and the percent of the time the line item is to be run at the specified priority level (e.g., “run Line Item A 50% of the time at a high priority”). The system would then run the line item in accordance with the conditional rule. Conditional priorities may be used, by way of example, to enable RTB-style guarantees on the server side.

The system is optionally configured to execute a “conditional extension” specified by a user via a user interface. For example, a user interface may be provided enabling the user to specify an extension period for a line item, specify a condition that would trigger the extension (although a default condition may be utilized), and/or an action (e.g., delivery type) to be taken with respect to serving impressions (e.g., serve impressions as fast as possible) if the extension is triggered. The extension period that can be set by a user may be capped to a maximum amount. For example, the user interface may enable the user to enter an extension period as a number of days, and the cap may be preset at seven days.

By way of illustration, the user interface may be configured to enable a user to set an extension period as a number of days or weeks, set the condition to be a failure to meet an impression goal by a campaign end date, and set the action to be serving impressions during the extension period ‘as fast as possible’. The system will accordingly execute the conditional extension upon detection of the occurrence of the specified condition. If the system determines that the goal cannot be met during the extension with the specified delivery type, then the line item execution will terminate. Optionally, a user interface may be generated that displays operative line items, where line items in their extension period are emphasized (e.g., using color, placement, icons, or otherwise).

A user interface optionally enables the user to specify whether the system should implement front loading of ad impressions, and the amount of front loading (e.g., where the user may specify what percent of the ad impression goal is to be met by what day of the campaign (e.g., 65% at the campaign midpoint) or whether the user specifies a factor (e.g., a percentage) by which each day in a specified number of days is to exceed its impression goal (e.g., 5% per day for the first third of the campaign). The front-loading tolerance may be specified on a per-account basis. Optionally, the system enables front-loading to be overridden on a per-line-item basis, as specified by the user via a user interface.

Optionally, the system may identify expected traffic spikes to the user, and enable the user to purchase some or all of the traffic spikes' impressions, optionally without having to change the campaign end date. If the user purchases some or all of the traffic spikes' impressions, optionally the system may recalculate the delivery schedule to account for the increase of impressions served during the spike by reducing the number of impressions served at other times.

If the user selects “sponsorship” as the line item type via the user interface illustrated in FIG. 6, the system prevents sponsorships from being run on the properties of other sellers. The user interface enables the user to specify one or more fee types, such as flat fee, flat fee per day, fixed-CPM price types, etc. Optionally, the user interface is configured to prevent user entry of bidded-CPM, CPM-C and CPC price_types for sponsorship line items.

Optionally, the system is configured to detect if there is already a sponsorship in the requested date range with overlapping placement criteria (e.g., where the same sites, geographic target area, and/or other properties are specified). If the system detects such a conflict, the system may report the conflict to the user via a user interface and enable the user to change the criteria and/or the date range. If overlapping sponsorships are instituted, the system may ensure that they share requests proportionally to the percent traffic they have received over a specified recent time horizon (e.g., the last day, the last week, etc.).

As similarly discussed above with respect to guaranteed line items, the user interface optionally enables a priority level to be specified and optionally enables a percentage-based goal for a sponsorship to be specified.

Certain definitions will now be provided with respect to terminology used herein.

Impression: An opportunity for a user to view an advertisement.

Viewable Impression: Impression known to have appeared on-screen (as opposed to being below the fold or covered by other content) for a certain amount of time.

Traffic: ad impressions or other metric (e.g., ad impressions may be used as the base metric for guaranteed sales, although other metrics may be used in addition or instead, such as viewable impressions, time spent on page, number of unique users, etc.).

Traffic History: previous delivery of impressions or another metric.

Unique Users: number of distinct browser or other distinct application/device identifiers (e.g., User Agent, Cookie and/or Registration ID) that have visited or accessed a given inventory for a given time period (e.g., on a particular day), which provides an approximation as to the number of individual users accessing a given inventory.

Forecast: an estimate of future traffic, unique users, and/or other metrics based on traffic history (e.g., including day of week and day of month), optionally adjusted for seasonality or overrides.

Raw Forecast: an estimate of future traffic based purely on past traffic.

Availability: an estimate of forecasted traffic remaining after accounting for competing commitments and buffering.

Availability Buffer: a safety margin built into the inventory availability report to account for imperfect forecasts and traffic overlaps (e.g., report only a set percentage (e.g., 75%) of the inventory that is estimated to be available).

Raw Availability: inventory availability without the buffering (raw availability may be useful for analysis and troubleshooting).

Forecasting will now be discussed in greater detail. A forecast may include some or all of the following dimensions:

| Category | Attribute |
|---|---|
| Date | Start Date |
| | End Date |
| Inventory | Site |
| | Zone |
| | Size |
| | Inventory type |
| | rp_inventory (registered values) |
| Audience | rp_visitor (registered values) |
| | Pixel (if doing a retargeting campaign) |
| | Third party data |
| Geo | Continent |
| | Country |
| | State |
| | Metro Area |
| | Postal Code |
| | City |
| | Area code |
| Device | Browser |
| | Carrier |
| | Language |
| | Connection Type |
| | Model |
| | Operating system |
| Day Part | Fixed date |
| | Fixed day of week |
| | Hour of day |
| Frequency | Frequency cap (e.g. per day/lifetime) |
| Uniques | Uniques |

Providing useful, sufficiently accurate forecasts is conventionally challenging. Forecasts are typically based on the assumption of reliable historical information, a steady-state future, and reasonable sell-through rates. However, there are many instances where the foregoing will not be true. For example, for a new property (e.g., a new website) or zone (a portion of a property set aside for an ad, such as a portion of a webpage, a forum, an article, a buying guide, etc.), there may be no available ad traffic history, yet there may be high traffic expectations. By way of further example, an ad sale change may split out an existing property or zone ratecard into two or more separate sellable units, or may merge existing two or more existing properties or zones into one property or zone. By way of yet further example, an editorial change (e.g., removing ad calls, cross-promoting properties or zones, a site redesign, etc.) may affect ad traffic. By way of still further example, a previously existing property or zone may be shut-down as of a specific date. By way of further example, a known peak traffic season or planned event may be upcoming and the expected extra traffic will be sold. By way of further example, a big traffic spike or traffic trough was recently experienced by the property, and the abnormal numbers will skew skewing forecasts.

In order to address one or more of the foregoing challenges, the system may include a forecasting engine that provides some or all of the following forecasting controls.

Abnormality threshold definition controls may be provided which may be set by user that cause the system to smooth or ignore data for a particular non-standard day (or other time period) where abnormal traffic has been detected (e.g., the user can specify that if a zone's traffic for a given day is more than 2-standard-deviations from the average traffic, then that day's traffic is not to be used in generating a traffic forecast).

Traffic override controls which may be set by user, where the user can specify, for past days at a specified property/zone/size and/or country level, the metric to override or a scalar by which to scale the actual history (e.g., a specified period of historical information or all the history being used in the forecast).

Traffic override controls may be provided which may be set by user to override average impressions per user and/or win price at a specified property/zone/size and/or country level.

Traffic override controls may be provided which may be set by the user to override future days or other period of time at a specified site/zone/size and/or country, specifying the metric to override and/or a scalar by which to scale a raw forecast. Similarly, traffic override controls may be provided which may be set by the user to override future days or other period of time at a specified site/zone/size and/or country with respect to average impressions per user and/or win price. Optionally, some or all of the override controls are provided at the dimension level as well, which may be particularly advantageous in urgent situations (e.g., where website Super Bowl traffic from a particular Designated Market Area (DMA) is expected to be much higher than usual for a particular city). Optionally, overrides specified for future days are prevented from automatically rolling-over to become overrides for past days, and in such case, overrides for past days must be explicitly set.

In order to reduce the possibility of overselling a particular property, the system may enable a user, such as a seller, to set custom availability buffers for different parts of a property (e.g., a website) so that some parts of a property are assigned a different availability buffer than other parts of the same property. For example, in order to avoid missing guarantees, if a portion of a seller's site has a type of hard-to-forecast targeting, the seller may place a larger buffer for this portion, while using a default availability buffer for other portions of the site that are not as hard to forecast. For example, a user interface may be provided enabling the user to enter, and the system to receive, one or more such custom buffers.

Optionally, an initial forecast report may be generated prior to the setting of the forecasting override and/or other controls.

Forecasts performed by the system may be based on a price distribution rather than a single impression estimate. For example, a forecast may be based on a specified bid price winning one or more specified zones a specified percentage of the time (e.g., “a bid price of $5 will win 75% of impressions on zone-size 1234-15”).

With reference to the foregoing disclosure, optionally processes and calculations described herein as being performed on an ad exchange server may instead be executed, in whole or in part, by a client (e.g., a user/consumer terminal accessing web content which will be displayed in conjunction with an ad) and/or by a bidder server.

Optionally, the architecture disclosed herein enables publishers to offer inventory to multiple ad exchanges simultaneously before making calls to ad servers, thereby letting multiple demand sources bid on the same inventory at the same time. For example, publishers may include code (e.g., a script which acts as a smart tag) in the header of their webpages (or elsewhere), enabling demand sources to submit bids before the ad server is called. If the auction clears, the appropriate line item in the ad server will deliver to fulfill the impression. Thus, buyers and exchanges may submit real-time bids, before direct buys are transmitted to an ad server.

Optionally, the header code may include JSON (JavaScript Object Notation) or JSONP (JSON with padding) on the web page and a floor price may be passed for a given impression.

When the browser executes the smart tag code (e.g., placed by a seller in a webpage header), the ad engine is called via the smart tag. The ad engine runs the auction, and returns the result (comprising a returned tag, which may optionally comprise a guaranteed ad which won the auction, as similarly described above) in a response to the browser. The returned tag is not rendered yet, but rather is cached (e.g., in the JavaScript), awaiting for the final decision from the ad server. At some point later, the webpage, via the user agent, makes a normal request to the seller's ad server, providing a key-value pair that goes to the ad server, which adds an additional piece of targeting to the impression. In the ad server there is a line item that is looking for that key-value pair. When the key-value pair is detected, the ad server can choose to serve that line item, which is included in the response to the browser. If the line item serves, it contains a JavaScript code that accesses the creative from the previously cached smart tag and renders, using the user agent, the creative in the appropriate ad slot.

In the foregoing process, a webpage with an ad tag may communicate with the ad engine directly. The tag may be rendered in a particular ad slot on the webpage (rather than be located right below the ad engine call).

As discussed above, processes and systems are provided that enable guaranteed ads to compete for an impression in a unified auction rather than automatically winning the impression in a waterfall-type scenario. However, optionally processes and calculations (e.g., valuation calculations) described herein as being performed on an ad exchange server may instead be executed, in whole or in part, by a bidder server. For example, a publisher (or representative) may register their guaranteed ad campaign, via an API, with the ad exchange. Some or all of the following data may be included in the ad campaign registration: Deal Identifier (Deal ID), date range (e.g., start date and end date) for the campaign, ad delivery goal, contract price, priority, and targeting, criteria, and/or creative. Different processes may optionally be utilized by simple and sophisticated bidders. A Deal ID may be associated with a ‘guaranteed’ indicator, which will cause the ad exchange to use the bid price as the auction value, but use a preregistered price (e.g., a value specified in a contract) as the market value for the purposes of reporting, fees, and second pricing (the calculated auction charge price used if the guaranteed ad did not win the auction). A Deal ID may instead be associated with a “bid for me” indicator, which will cause the ad exchange to determine the value of the bid based on the preregistered price (e.g., using the algorithm described above, which may be executed by the exchange system).

For simple bidders, the following process may optionally be used. Once the start date is reached, the bidder starts receiving bid requests via the ad exchange with the Deal ID when the targeting criteria match an impression. The bidder may pass or bid on the received ad requests. When the bidder wants to bid on an ad request, the bidder responds with the Deal ID, the creative, and a special bid value (e.g., zero). The ad exchange confirms that the bid associated with the Deal ID is coming from an allowable source and is for an allowable impression request using corresponding Deal ID metadata and uses a pre-calculated auction value (e.g., calculated using the algorithm described above, which may be executed by the exchange system) in place of the special bid value received from the bidder. In this example, the market value of the impression is based on the contract price specified in the contract between the bidder and ad placement entity rather than the auction value.

For sophisticated bidders, the following process may optionally be used. Once the start date is reached, the bidder starts receiving bid requests with the Deal ID when the targeting criteria match an impression. The bidder may pass or bid on the received ad requests. When the bidder wants to bid on an ad request, the bidder responds with the Deal ID, the creative, and a bid value, which may be artificially large (e.g., $1000). The ad exchange confirms the Deal ID metadata, validates the bid by determining whether the bid is coming from an allowable source and is for an allowable impression request using corresponding Deal ID metadata, and then uses it as the auction value. In this example, the market value of the impression and managed revenue are based on the contract price specified in the contract between the bidder and ad placement entity rather than the auction value.

Thus, systems and methods are described that integrate guaranteed ads into an open real time bidding market and that enable the reduction of average system loading for a given ad impression auction.

The methods and processes described herein may have fewer or additional steps or states and the steps or states may be performed in a different order. Not all steps or states need to be reached. The methods and processes described herein may be embodied in, and fully or partially automated via, software code modules executed by one or more general purpose computers. The code modules may be stored in any type of computer-readable medium or other computer storage device. Some or all of the methods may alternatively be embodied in whole or in part in specialized computer hardware. The systems described herein may optionally include displays, user input devices (e.g., touchscreen, keyboard, mouse, voice recognition, etc.), network interfaces, etc.

The results of the disclosed methods may be stored in any type of computer data repository, such as relational databases and flat file systems that use volatile and/or non-volatile memory (e.g., magnetic disk storage, optical storage, EEPROM and/or solid state RAM).

The various illustrative logical blocks, modules, routines, and algorithm steps described in connection with the embodiments disclosed herein can be implemented as electronic hardware, computer software, or combinations of both. To clearly illustrate this interchangeability of hardware and software, various illustrative components, blocks, modules, and steps have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure.

Moreover, the various illustrative logical blocks and modules described in connection with the embodiments disclosed herein can be implemented or performed by a machine, such as a general purpose processor device, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor device can be a microprocessor, but in the alternative, the processor device can be a controller, microcontroller, or state machine, combinations of the same, or the like. A processor device can include electrical circuitry configured to process computer-executable instructions. In another embodiment, a processor device includes an FPGA or other programmable device that performs logic operations without processing computer-executable instructions. A processor device can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor device may also include primarily analog components. A computing environment can include any type of computer system, including, but not limited to, a computer system based on a microprocessor, a mainframe computer, a digital signal processor, a portable computing device, a device controller, or a computational engine within an appliance, to name a few.

The elements of a method, process, routine, or algorithm described in connection with the embodiments disclosed herein can be embodied directly in hardware, in a software module executed by a processor device, or in a combination of the two. A software module can reside in RAM memory, flash memory, ROM memory, EPROM memory, EEPROM memory, registers, hard disk, a removable disk, a CD-ROM, or any other form of a non-transitory computer-readable storage medium. An exemplary storage medium can be coupled to the processor device such that the processor device can read information from, and write information to, the storage medium. In the alternative, the storage medium can be integral to the processor device. The processor device and the storage medium can reside in an ASIC. The ASIC can reside in a user terminal. In the alternative, the processor device and the storage medium can reside as discrete components in a user terminal.

Conditional language used herein, such as, among others, “can,” “may,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without other input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Disjunctive language such as the phrase “at least one of X, Y, Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

While the phrase “click” may be used with respect to a user selecting a control, menu selection, or the like, other user inputs may be used, such as voice commands, text entry, gestures, etc. User inputs may, by way of example, be provided via an interface, such as via text fields, wherein a user enters text, and/or via a menu selection (e.g., a drop down menu, a list or other arrangement via which the user can check via a check box or otherwise make a selection or selections, a group of individually selectable icons, etc.). When the user provides an input or activates a control, a corresponding computing system may perform the corresponding operation. Some or all of the data, inputs and instructions provided by a user may optionally be stored in a system data store (e.g., a database), from which the system may access and retrieve such data, inputs, and instructions. The notifications and user interfaces described herein may be provided via a Web page, a dedicated or non-dedicated phone application, computer application, a short messaging service message (e.g., SMS, MMS, etc.), instant messaging, email, push notification, audibly, and/or otherwise.

The user terminals described herein may be in the form of a mobile communication device (e.g., a cell phone), laptop, tablet computer, interactive television, game console, media streaming device, head-wearable display, networked watch, etc. The user terminals may optionally include displays, user input devices (e.g., touchscreen, keyboard, mouse, voice recognition, etc.), network interfaces, etc.

While the above detailed description has shown, described, and pointed out novel features as applied to various embodiments, it can be understood that various omissions, substitutions, and changes in the form and details of the devices or algorithms illustrated can be made without departing from the spirit of the disclosure. As can be recognized, certain embodiments described herein can be embodied within a form that does not provide all of the features and benefits set forth herein, as some features can be used or practiced separately from others. The scope of certain embodiments disclosed herein is indicated by the appended claims rather than by the foregoing description. All changes which come within the meaning and range of equivalency of the claims are to be embraced within their scope.

What is claimed is:

1. A targeted content routing system, comprising:
a computer data repository that stores transaction records, the computer data repository comprising a plurality of geographically distributed non-transitory storage devices and configured to log content serving data and to synchronize content serving data among the plurality of geographically distributed datacenters, so that content serving data is replicated across the geographically distributed datacenters;
a network interface; and
a computing system comprising one or more computing devices, the computing system programmed to implement:
a content matching engine configured to determine which third party content is suitable for a webpage;
a unified auction engine configured to:
calculate an adjusted value for a first targeted guaranteed item of content associated with a first entity based at least in part on:
a previously specified value communicated with the first entity;
historical delivery performance accessed from the computer data repository for the first targeted guaranteed item of content during a first time period; and
a delivery schedule for the first targeted guaranteed item of content;
receive, using the network interface, a request for content from a user agent;
determine, utilizing the content matching engine, whether the first targeted guaranteed item of content is eligible to be delivered to the user agent based at least in part on:
at least one targeting criterion associated with the first targeted guaranteed item of content, and
a pace setting associated with the first targeted guaranteed item of content;
at least partly in response to a determination that the first targeted guaranteed item of content is eligible to be delivered to the user agent based at least in part on the targeting criterion and the pace associated with the first targeted guaranteed item of content, cause the first targeted guaranteed item of content to participate in a real time impression auction,
transmit, using the network interface, a request for open market bids to remote systems,
receive, using the network interface, from at least a portion of the remote systems a first plurality of open market bids, the first plurality of open market bids associated with respective bid values, for respective non-guaranteed items of content for an impression associated with the content request from the user agent;
determine if the adjusted value for the eligible first targeted guaranteed item of content is less than at least a first bid associated with a first non-guaranteed item of content;
at least partly in response to a determination that the adjusted value for the eligible first targeted guaranteed item of content is less than at least the first bid associated with the first non-guaranteed item of content, cause a non-guaranteed item of content to be routed for display to the user agent; and
at least partly in response to a determination that the adjusted value for the eligible first targeted guaranteed item of content is greater than the received first plurality of open market bids for respective non-guaranteed items of content, cause the first targeted guaranteed item of content to be routed for display to the user agent.

2. The targeted content routing system as defined in claim 1, wherein the calculation of the adjusted value for the first targeted guaranteed item of content associated with a first entity is based at least in part on:
a determination as to whether a campaign associated with the first guaranteed item of content is in a front loading stage;
a determination as to whether the campaign associated with the first guaranteed item of content is ahead of schedule, behind schedule, or on-schedule;
a priority level associated with the first targeted guaranteed item of content;
a scarcity associated with the impression associated with the content request from the user agent;
a determination as to a proximity of an end date associated with the campaign associated with the first guaranteed item of content; and
a determination as to whether a zone associated with the impression associated with the content request from the user agent is in an oversold state.

3. The targeted content routing system as defined in claim 1, wherein the calculation of the adjusted value for the first targeted guaranteed item of content associated with a first entity is based at least in part on:
a time zone associated with a physical location of the user agent; and
a traffic pattern.

4. The targeted content routing system as defined in claim 1, wherein the unified auction engine is further configured to:
determine if the first entity has specified that the first targeted guaranteed item of content is not to compete with open market bids if a zone associated with the impression associated with the content request from the user agent is in an oversold state;
at least partly in response to detecting an oversold state associated with the zone and a determination that the first entity has specified that the first targeted guaranteed item of content is not to compete with open market bids if a zone associated with the impression associated with the content request from the user agent is in an oversold state, inhibit a non-guaranteed item of content from being routed for display to the user agent.

5. The targeted content routing system as defined in claim 1, wherein the at least one targeting criterion comprises one or more targeting criteria, including:
a targeting criterion related to an online property,
a targeting criterion related to a user's historical network traffic, the network traffic comprising at least sites visited,
a targeting criterion related to user demographics,
a targeting criterion related to time of day,
a targeting criterion related to geographic location, or
a targeting criterion related to a scheduled occurrence of an event.

6. The targeted content routing system as defined in claim 1, wherein the pace setting associated with the first targeted guaranteed item of content specifies a percentage of auctions the first targeted guaranteed item of content is eligible to compete in.

7. The targeted content routing system as defined in claim 1, wherein the unified auction engine is further configured to dynamically adjust the pace setting at least partly in response to detecting an under-delivery condition or an over-delivery condition.

8. The targeted content routing system as defined in claim 1, wherein the unified auction engine is further configured to:
at least partly in response to determining that the adjusted value for the eligible first targeted guaranteed item of content is equal to a highest of the received first plurality of open market bids for respective non-guaranteed items of content:
determine which of the first targeted guaranteed item of content and the non-guaranteed item of content associated with the highest of the received first plurality of open market bids has a higher priority; and
cause the item of content with the higher priority to be routed for display to the user agent.

9. A computerized method of routing targeted content, the method comprising:
calculating, by a content routing system comprising a data processing device, a real time impression auction system, and a campaign data store that stores at least campaign targeting criteria and campaign schedules, an adjusted value for a first targeted guaranteed item of content associated with a first entity based at least in part on:
a previously specified value communicated with the first entity;
historical delivery performance for the first targeted guaranteed item of content during a first time period; and
a delivery schedule for the first targeted guaranteed item of content;
receiving, at the content routing system, a request for content from a user agent;
determining, by the content routing system, whether the first targeted guaranteed item of content is eligible to be delivered to the user agent based at least in part on:
at least one targeting criterion associated with the first targeted guaranteed item of content, and
a pace setting associated with the first targeted guaranteed item of content;
at least partly in response to determining that the first targeted guaranteed item of content is eligible to be delivered to the user agent based at least in part on the targeting criterion and the pace associated with the first targeted guaranteed item of content, causing the first targeted guaranteed item of content to participate in a real time impression auction hosted by the real time impression auction system,
requesting, using the real time impression auction system, open market bids from a plurality of remote systems,
receiving, by the real time impression auction system, a first plurality of open market bids from at least a portion of the plurality of remote system, the first plurality of open market bids associated with respective bid values, for respective non-guaranteed items of content for an impression associated with the content request from the user agent;
determining, by the real time impression auction system, if the adjusted value for the eligible first targeted guaranteed item of content is less than at least a first bid associated with a first non-guaranteed item of content;
at least partly in response to determining that the adjusted value for the eligible first targeted guaranteed item of content is less than at least the first bid associated with the first non-guaranteed item of content, causing, by the real time impression auction system, a non-guaranteed item of content to be routed for display to the user agent; and
at least partly in response to determining that the adjusted value for the eligible first targeted guaranteed item of content is greater than the received first plurality of open market bids for respective non-guaranteed items of content, causing, by the real time impression auction system, the first targeted guaranteed item of content to be routed for display to the user agent.

10. The method of routing targeting content as defined in claim 9, wherein calculating, by the content routing system, the adjusted value for the first targeted guaranteed item of content associated with a first entity is based at least in part on:
a determination as to whether a campaign associated with the first guaranteed item of content is in a front loading stage;
a determination as to whether the campaign associated with the first guaranteed item of content is ahead of schedule, behind schedule, or on-schedule;
a priority level associated with the first targeted guaranteed item of content;
a scarcity associated with the impression associated with the content request from the user agent;
a determination as to a proximity of an end date associated with the campaign associated with the first guaranteed item of content; and
a determination as to whether a zone associated with the impression associated with the content request from the user agent is in an oversold state.

11. The method of routing targeting content as defined in claim 10, wherein calculating, by the content routing system, the adjusted value for the first targeted guaranteed item of content associated with a first entity is based at least in part on:
a time zone associated with a physical location of the user agent; and
a traffic pattern.

12. The method of routing targeting content as defined in claim 9, the method further comprising:
determining if the first entity has specified that the first targeted guaranteed item of content is not to compete with open market bids if a zone associated with the impression associated with the content request from the user agent is in an oversold state;
at least partly in response to detecting an oversold state associated with the zone and a determination that the first entity has specified that the first targeted guaranteed item of content is not to compete with open market bids if a zone associated with the impression associated with the content request from the user agent is in an oversold state, inhibiting a non-guaranteed item of content from being routed for display to the user agent.

13. The method of routing targeting content as defined in claim 9, wherein the at least one targeting criterion comprises one or more targeting criteria, including:
a targeting criterion related to an online property,
a targeting criterion related to a user's historical network traffic, the network traffic comprising at least sites visited,
a targeting criterion related to user demographics,
a targeting criterion related to time of day,
a targeting criterion related to geographic location, or
a targeting criterion related to a scheduled occurrence of an event.

14. The method of routing targeting content as defined in claim 9, wherein the pace setting associated with the first targeted guaranteed item of content specifies a percentage of auctions the first targeted guaranteed item of content is eligible to compete in.

15. The method of routing targeting content as defined in claim 9, the method further comprising dynamically adjusting the pace setting at least partly in response to detecting an under-delivery condition or an over-delivery condition, and thereby causing delivery of the first targeted guaranteed item of content to be delivered in accordance with the delivery schedule.

16. The method of routing targeting content as defined in claim 9, the method further comprising:
at least partly in response to determining that the adjusted value for the eligible first targeted guaranteed item of content is equal to a highest of the received first plurality of open market bids for respective non-guaranteed items of content:
determining which of the first targeted guaranteed item of content and the non-guaranteed item of content associated with the highest of the received first plurality of open market bids has a higher priority; and
causing the item of content with the higher priority to be routed for display to the user agent.

17. The method of routing targeting content as defined in claim 9, the method further comprising synchronizing content serving data among a plurality of geographically distributed datacenters, wherein at least a portion of the geographically distributed datacenters comprise real time impression auction systems, so that content serving data is replicated across the geographically distributed datacenters and the real time impression auction systems have recent content serving data used to control at least in part pacing of a given item of content.

18. The method of routing targeting content as defined in claim 9, the method further comprising calculating, by a bidding system comprising a processing device, a second adjusted value for a second targeted guaranteed item of content.

19. The method of routing targeting content as defined in claim 9, the method further comprising:
prior to the real time impression auction, providing programmatic code to an online content provider to be included in a web page, wherein the when the programmatic code is executed by the user agent, an auction call is transmitted by the user agent to the content routing system,
receiving the auction call from the user agent at the content routing system;
conducting, by the content routing system, a second auction, wherein the second auction is conducted prior to the real time impression auction;
prior to the real time impression auction, transmitting, by the content routing system, a result for the second auction to the user agent, the result comprising a guaranteed item of content which won the second auction, wherein the user agent caches the guaranteed item of content included in the second auction result without rendering the guaranteed item of content included in the second auction result;
after the real time impression auction is conducted, determining whether the guaranteed item of content included in the second auction result is to be rendered by the user agent or whether the first targeted guaranteed item of content is to be rendered by the user agent, and in response, causing either the guaranteed item of content included in the second auction result or the first targeted guaranteed item of content to be rendered by the user agent.

20. A computer storage system comprising a non-transitory storage device, said computer storage system having stored thereon executable program instructions that direct a computer system to at least:
calculate an adjusted value for a first targeted guaranteed item of content associated with a first entity based at least in part on:
a previously specified value communicated with the first entity;
historical delivery performance for the first targeted guaranteed item of content during a first time period; and
a delivery schedule for the first targeted guaranteed item of content;
receive a request for content from a user agent;
determine whether the first targeted guaranteed item of content is eligible to be delivered to the user agent based at least in part on:
at least one targeting criterion associated with the first targeted guaranteed item of content, and
a pace setting associated with the first targeted guaranteed item of content;
at least partly in response to a determination that the first targeted guaranteed item of content is eligible to be delivered to the user agent based at least in part on the targeting criterion and the pace associated with the first targeted guaranteed item of content, cause the first targeted guaranteed item of content to participate in a real time impression auction,
transmit a request for open market bids to one or more systems,
receive from at least a portion of the one or more systems a first plurality of open market bids, the first plurality of open market bids associated with respective bid values, for respective non-guaranteed items of content for an impression associated with the content request from the user agent;
determine if the adjusted value for the eligible first targeted guaranteed item of content is less than at least a first bid associated with a first non-guaranteed item of content;
at least partly in response to a determination that the adjusted value for the eligible first targeted guaranteed item of content is less than at least the first bid associated with the first non-guaranteed item of content, cause a non-guaranteed item of content to be routed for display to the user agent; and
at least partly in response to a determination that the adjusted value for the eligible first targeted guaranteed item of content is greater than the received first plurality of open market bids for respective non-guaranteed items of content, cause the first targeted guaranteed item of content to be routed for display to the user agent.

21. The computer storage system as defined in claim 20, wherein the calculation of the adjusted value for the first targeted guaranteed item of content associated with a first entity is based at least in part on:
a determination as to whether a campaign associated with the first guaranteed item of content is in a front loading stage;
a determination as to whether the campaign associated with the first guaranteed item of content is ahead of schedule, behind schedule, or on-schedule;
a priority level associated with the first targeted guaranteed item of content;
a scarcity associated with the impression associated with the content request from the user agent;
a determination as to a proximity of an end date associated with the campaign associated with the first guaranteed item of content; and
a determination as to whether a zone associated with the impression associated with the content request from the user agent is in an oversold state.

22. The computer storage system as defined in claim 20, wherein the calculation of the adjusted value for the first targeted guaranteed item of content associated with a first entity is based at least in part on:
a time zone associated with a physical location of the user agent; and
a traffic pattern.

23. The computer storage system as defined in claim 20, wherein the executable program instructions are further configured to direct a computer system to:
determine if the first entity has specified that the first targeted guaranteed item of content is not to compete with open market bids if a zone associated with the impression associated with the content request from the user agent is in an oversold state;
at least partly in response to detecting an oversold state associated with the zone and a determination that the first entity has specified that the first targeted guaranteed item of content is not to compete with open market bids if a zone associated with the impression associated with the content request from the user agent is in an oversold state, inhibit a non-guaranteed item of content from being routed for display to the user agent.

24. The computer storage system as defined in claim 20, wherein the at least one targeting criterion comprises one or more targeting criteria, including:
a targeting criterion related to an online property,
a targeting criterion related to a user's historical network traffic, the network traffic comprising at least sites visited,
a targeting criterion related to user demographics,
a targeting criterion related to time of day,
a targeting criterion related to geographic location, or
a targeting criterion related to a scheduled occurrence of an event.

25. The computer storage system as defined in claim 20, wherein the pace setting associated with the first targeted guaranteed item of content specifies a percentage of auctions the first targeted guaranteed item of content is eligible to compete in.

26. The computer storage system as defined in claim 20, wherein the executable program instructions are further configured to direct a computer system to dynamically adjust the pace setting at least partly in response to detecting an under-delivery condition or an over-delivery condition.

27. The computer storage system as defined in claim 20, wherein the executable program instructions are further configured to direct a computer system to:
at least partly in response to determining that the adjusted value for the eligible first targeted guaranteed item of content is equal to a highest of the received first plurality of open market bids for respective non-guaranteed items of content:
determine which of the first targeted guaranteed item of content and the non-guaranteed item of content associated with the highest of the received first plurality of open market bids has a higher priority; and
cause the item of content with the higher priority to be routed for display to the user agent.

28. The computer storage system as defined in claim 20, wherein the executable program instructions are further configured to direct a computer system to synchronize content serving data among a plurality of geographically distributed datacenters, wherein at least a portion of the geographically distributed datacenters comprise real time impression auction systems, so that content serving data is replicated across the geographically distributed datacenters and the real time impression auction systems have recent content serving data used to control at least in part pacing of a given item of content.
